(19) United States
(12) Patent Application Publication
(10) Pub. No.: US 2021/0243509 A1
(43) Pub. Date: Aug. 5, 2021

(54) ELEVATED FLOOR WITH INTEGRATED ANTENNAS

(71) Applicant: Johnson Controls Technology Company, Auburn Hills, MI (US)

(72) Inventors: ZhongYi Jin, Santa Clara, CA (US); Youngchoon Park, Brookfield, WI (US); Wenwen Zhao, Santa Clara, CA (US)

(73) Assignee: Johnson Controls Technology Company, Auburn Hills, MI (US)

(21) Appl. No.: 17/166,790

(22) Filed: Feb. 3, 2021

Related U.S. Application Data
(60) Provisional application No. 62/970,596, filed on Feb. 5, 2020.

(51) Int. Cl. H04Q 9/00; E04F 15/024; H04B 17/318

(52) U.S. Cl. CPC H04Q 9/00; H04Q 2209/40; H04B 17/318; E04F 15/02411

(57) ABSTRACT

A floor tile for an elevated floor in a building includes a non-through aperture defining a pocket within the floor tile having a base and one or more walls, an antenna disposed within the non-through aperture and configured to be communicably coupled to an access point, the antenna configured to transmit wireless signals, one or more reflective surfaces positioned on an inner surface of the non-through aperture and configured to reflect the wireless signals, and a shielding layer disposed on top of the antenna and configured to cover the non-through aperture to protect the antenna from an external environment.

### CROSS-REFERENCE TO RELATED PATENT APPLICATIONS

This application claims the benefit and priority of U.S. Provisional Patent Application No. 62/970,596 filed on Feb. 5, 2020, the entire disclosure of which is incorporated by reference herein.

### BACKGROUND

The present disclosure relates generally to elevated floor above a solid substrate. The present disclosure relates more particularly to elevated floor having integrated antennas.

Building automation, or smart homes, has enhanced the quality of life of their users. A building management system (BMS), in general, is a system of devices configured to control, monitor, and manage equipment in or around a building or building area. A BMS can include a heating, ventilation, and air conditioning (HVAC) system, a security system, a lighting system, a fire alerting system, another system that is capable of managing building functions or devices, or any combination thereof. BMS devices can be installed in any environment (e.g., an indoor area or an outdoor area) and the environment can include any number of buildings, spaces, zones, rooms, or areas. A BMS can include a variety of devices (e.g., HVAC devices, controllers, chillers, fans, sensors, etc.) configured to facilitate monitoring and controlling the building space. Throughout this disclosure, such devices are referred to as BMS devices or building equipment.

Some building management system (BMS) or building automation system (BAS) provide a way to automate and control BMS devices based on various factors such as time, frequency, and ambient conditions. Typically, the BMS devices are integrated together to provide convenience and a better living experience. Moreover, the ubiquitousness of internet connections has made it possible for a user to monitor and control the BMS devices remotely. However, to facilitate a user to monitor and control the BMS devices, the amount of wireless data communication access points being installed in a building has increased exponentially. Multiple access points are required to be deployed in a single building to provide a seamless wireless network connectivity and to achieve good spatial coverage of data signals.

The need for multiple access points in turn creates a data network that requires installation of data cables in the building to connect the access points to the building. From the standpoint of structural convenience, safety/reliability, and aesthetics, it is desirable to embed the cable within the building wall. Although the option of embedding cables within the building wall is feasible while the building is being built, it may be inconvenient, infeasible, laborious, and/or expensive to install data cables in existing buildings, unless said data cable are fixed to the wall surface.

Conventionally, the access points are positioned on or proximal to an upper interior surface of a room or a compartment of the building to minimize their visual impact and facilitate uninterrupted signal coverage in the building space. This approach, however, makes access points difficult to access for maintenance, repairs, and the like. Additionally, the deployment of multiple overhead access points compromises the aesthetics of the building space.

To overcome the aforementioned drawbacks, access points may be positioned under an elevated or raised floor. However, this approach requires an antenna to be disposed in a pocket that is cut near the surface of a floor tile. The depth of the pocket is typically kept greater than the height of the antenna so the pocket can be filled with materials to protect the antenna and to bear load. The wall of the pocket however tends to block the wireless signals and create shadowing effect where there are no wireless signal in the shadowed region. This significantly limits the performance (signal strength/coverage areas) of traditional antennal panel design when employed in this approach.

There is, therefore, a need to provide an elevated floor with integrated antennas that alleviates the abovementioned drawbacks of conventional techniques and enhances the performance of under raised floor access points.

### SUMMARY

One implementation of the present disclosure is a floor tile for an elevated floor. The floor tile includes a non-through aperture defining a pocket within the floor tile having a base and one or more walls, an antenna disposed within the non-through aperture and configured to be communicably coupled to an access point, the antenna configured to transmit wireless signals, one or more reflective surfaces positioned on an inner surface of the non-through aperture and configured to reflect the wireless signals, and a shielding layer disposed on top of the antenna and configured to cover the non-through aperture to protect the antenna from an external environment.

In some embodiments, the floor tile further includes at least one through-hole extending from the base of the non-through aperture to a bottom of the floor tile. In some embodiments, one or more cables are passed through the through-hole for establishing a connection between the antenna and the access point, the access being located below the elevated floor.

In some embodiments, the floor tile further includes an airtight seal positioned on an outer edge of the floor tile to prevent formation of one or more gaps between the floor tile and one or more adjacent tiles.

In some embodiments, the shielding layer includes a material having a low wireless signal attenuation.

In some embodiments, the antenna is configured to transmit a portion of the wireless signals upward through an opening of the non-through aperture, and a remaining portion of the wireless signals is reflected by the one or more reflective surface and outward from the floor tile through the opening of the non-through aperture.

In some embodiments, the one or more reflective surfaces are attached to the one or more walls of the non-through aperture.

In some embodiments, an inner surface of the non-through aperture includes a reflective material.

In some embodiments, the one or more reflective surfaces are positioned such that a shadow region in which the wireless signals are blocked is less than five degrees from the surface of the tile.

In some embodiments, the floor tile is a first floor tile, and the elevated floor is defined by a plurality of floor tiles including the first floor tile, the plurality of floor tiles supported on a plurality of columns extending from a solid substrate beneath the elevated floor.

Another implementation of the present disclosure a system for locating assets within a building. The system includes one or more access points positioned under an elevated floor of the building and configured to periodically transmit a unique identifier, one or more antennas coupled to the one or more access points and configured to wirelessly broadcast the unique identifier for a corresponding one of the one or more access points, the one or more antennas disposed within a non-through aperture of one or more tiles of the elevated floor, and one or more memory devices having instructions stored thereon that, when executed by one or more processors, cause the one or more processors to perform operations including receiving, from a first asset, first data including a unique identifier for a first access point of the one or more access points, identifying the first access point based on the unique identifier, and determining location coordinates of the first asset within the building based on a location of the identified first access point.

In some embodiments, the unique identifier of the first access point is a first unique identifier, the first data further includes a signal strength associated with the wireless broadcast of the first unique identifier, and determining the location coordinates of the first asset within the building is further based on the signal strength.

In some embodiments, the operations further include receiving, from the first asset, second data including a second unique identifier for a second access point of the one or more access points and a signal strength associated with the wireless broadcast of the second unique identifier and identifying the second access point based on the second unique identifier. In some embodiments, determining the location coordinates of the first asset within the building is further based on a location of the identified second access point and the signal strength associated with the second unique identifier.

In some embodiments, determining the location coordinates of the first asset based on a location of the identified first access point and the signal strength includes crawling through a first lookup table to extract the location coordinates corresponding to the unique identifier of the first access point, analyzing the signal strength and the location coordinates of the first access point to determine a plurality of potential coordinates of the first asset based on a signal strength map, and determining the location coordinates of the first asset by selecting one of the plurality of potential coordinates as the location coordinates.

In some embodiments, the operations further include transmitting, to the first asset, a floor plan indicating a location of the first asset within the building based on the location coordinates and locations of one or more additional assets within the building. In some embodiments, the first asset is configured to display the floor plan and the locations via a user interface.

In some embodiments, the first asset is configured to receive, prior to transmitting the first data, one or more unique identifiers corresponding to the one or more access points, determine, for the one or more unique identifiers, a corresponding signal strength, and identify a subset of the one or more access points having a signal strength greater than a threshold value, the subset of the one or more access point including the first asset.

In some embodiments, the one or more access points define a first set of access points, the system further including a second set of access points positioned on a wall or ceiling of the building, the second set of access points including integrated antennas.

In some embodiments, the unique identifier of the first access point is a first unique identifier, the operations further including receiving, from the first asset, second data including a second unique identifier for a second access point of the second set of access points and a signal strength associated with the wireless broadcast of the second unique identifier, identifying the second access point based on the second unique identifier, and determining location coordinates of the first asset within the building based on a location of the identified second access point, the location of the first access point, and the signal strength associated with the first unique identifier and the second unique identifier.

In some embodiments, the non-through aperture of the one or more tiles of the elevated floor includes one or more reflective surfaces for directing the wireless broadcast of the unique identifier upward from the elevated floor.

In some embodiments, the one or more tiles include a shielding layer disposed over a corresponding one of the one or more antennas, the shielding layer having a low wireless signal attenuation and configured to cover the non-through aperture of the one or more tiles to protect the corresponding one of the one or more antennas.

Yet another implementation of the present disclosure is a method of locating an asset within a building. The method includes transmitting, by a first access point located under an elevated floor of a building, a wireless signal including a unique identifier associated with the first access point, the wireless signal transmitted by a first antenna disposed within a non-through aperture of a tile of the elevated floor and coupled to the first access point, receiving, by a one or more processors and from a first asset with the building, first data including a copy of the unique identifier associated with the first access point and a signal strength associated with the wireless transmission of the unique identifier, identifying, by the one or more processors, the first access point based on the unique identifier, and determining location coordinates for the first asset within the building based on a location of the identified first access point and the signal strength.

Yet another implementation of the present disclosure is a method for providing an elevated floor with integrated antennas. The method includes configuring a non-through aperture on one or more tiles of the elevated floor, disposing an antenna within the non-through aperture and connecting the antenna with an access point secured on a solid substrate below the elevated floor, and providing one or more reflective surfaces within the non-through aperture, and the reflective surface is configured to facilitate reflection of impinging wireless signals, transmitted by the antenna, towards a space defined above the elevated floor.

In some embodiments, the method further includes covering the non-through aperture by applying a shielding layer over an operative top of the antenna, and the shielding layer is configured to shield the antenna from the environment.

In some embodiments, the shielding layer is manufactured using a material having low wireless signal attenuation.

In some embodiments, connecting the antenna with the access point is performed by configuring at least one hole on the tile to facilitate passage of one or more cables therethrough, and the hole extends from an operative bottom portion of the non-through aperture.

In some embodiments, the shape of one or more reflective surface is selected from circle, oval, ellipse, curve, wave, spiral, bubble, cone, ring, cross, triangle, square, rectangle, hexagon, octagon, crescent, or any other geometrical and non-geometrical shape.

In some embodiments, the method further includes configuring an airtight seal on an outer periphery of the tile to prevent formation of one or more gaps between adjacent tiles leading to leakage of air from underfloor air distribution supply plenums.

Yet another implementation of the present disclosure is a method for indoor localization of an asset. The method includes receiving, by an electronic unit of the asset, a plurality of first wireless signals transmitted by a plurality of first access points, and the first access points are spatially located in an indoor space including ceiling and walls, receiving, by the electronic unit, a plurality of second wireless signals transmitted by a plurality of second access points, and the second access points are located under an elevated floor, and each of the second access points is associated with an antenna integrated with a tile of the elevated floor, determining, by the electronic unit, the signal strength of each of the first access points and the second access points by evaluating the received first wireless signals and second wireless signals, identifying, by the electronic unit, at least one first access point and at least one second access point, and the identified first access point and second access point have signal strength greater than or equal to a pre-determined threshold signal strength, transmitting, by the electronic unit, the signal strength and identification information corresponding to each of the identified first and second access points, and determining, by a controller, location coordinates of the asset based on the received signal strength and identification information corresponding to each of the identified first and second access points, and the electronic unit is implemented using at least one processor.

In some embodiments, determining the location coordinates of the asset, by the controller, is done by extracting, the location coordinates of the one or more identified first access points by crawling through a first lookup table stored in a memory, and the first lookup table includes a list of first access points, and identification information and location coordinates corresponding to each of the first access points, extracting, the location coordinates of the one or more identified second access points by crawling through a second lookup table stored in the memory, and the second lookup table includes a list of second access points, and identification information and location coordinates corresponding to each of the second access points, extracting, signal strength map corresponding to each of the identified first and second access points, and the memory is configured to store a signal strength map corresponding to each of the first and second access points, analyzing, signal strength and location coordinates of each of the identified first and second access points to determine potential coordinates of the asset on the signal strength map of each of the identified first and second access points, and determining, the location coordinates of the asset by overlapping the signal strength map of each of the identified first and second access points and by electing one of the potential coordinates which exists in each of the strength maps as the location coordinates.

In some embodiments, integrating the antenna with the tile of the elevated floor includes the steps of configuring, a non-through aperture on the tile, disposing, the antenna within the non-through aperture and connecting the antenna with the second access point secured on a solid substrate below the elevated floor, and providing, one or more reflective surfaces within the non-through aperture and the reflective surface is configured to facilitate reflection of impinged wireless signals transmitted by the antenna towards an indoor space.

In some embodiments, integrating the antenna with the tile of the elevated floor further includes the step of covering the non-through aperture by applying a shielding layer over an operative top of the antenna, and the shielding layer is configured to shield the antenna from the environment.

Yet another implementation of the present disclosure is an indoor navigation system. The system includes a plurality of first access points spatially distributed in an indoor space having ceiling and walls, and each of the first access points is configured to periodically transmit a first wireless signal having an identification information, a plurality of second access points located under an elevated floor, and each of the second access points is associated with an antenna integrated with a tile of the elevated floor, and configured to periodically transmit a second wireless signal having an identification information, a location identifier, implemented using one or more processor(s) and associated within a portable electronic device of a user, the location identifier in response to receiving an indication to navigate having a target location coordinates, is configured to receive the plurality of first wireless signals and the plurality of second wireless signals associated with the first access points and the second access points respectively, determine the signal strength of each of the first and second wireless signals, determine the location coordinates of the user by evaluating the signal strength and pre-defined location coordinates of each of the first and second access points, and the pre-defined location coordinates of the each of the first and second access points is stored in a memory of the portable electronic device, and generate a navigable route between the location coordinates of the user and the target location coordinates.

In some embodiments, each of the plurality of first access points is either mounted on a ceiling or a wall defining the indoor space.

In some embodiments, the target location coordinates corresponds to location coordinates of an asset determined using the signal strength of first access points and the signal strength of second access points.

In some embodiments, the target location coordinates corresponds to selection of location coordinates from a floor plan of the indoor space, and the floor plan of the indoor space is pre-stored in a memory of the portable electronic device associated with the user.

In some embodiments, the evaluation of signal strength and pre-defined location coordinates of each of the first and second access points to determine location coordinates of the user, is performed by identifying, at least one first access point and at least one second access point having signal strength greater than or equal to a pre-defined threshold signal strength, analyzing, the signal strength and location coordinates of each of the identified first and second access points to determine potential coordinates of the user on the signal strength map of each of the identified first and second access points, and determining, the location coordinates of the user by overlapping the signal strength map of each of the identified first and second access points and by electing one of the potential coordinates which exists in each of the strength maps as the location coordinates, and the signal strength map of each of the first and second access points is stored in the memory of the portable electronic device.

In some embodiments, the navigable route generated by the location identifier is displayed on the user interface of the portable electronic device of the user.

In some embodiments, a non-through aperture is configured on the tile to house the antenna, and one or more reflective surfaces are provided within the non-through aperture to facilitate reflection of impinging wireless signals towards an indoor space.

In some embodiments, the tile includes a shielding layer which is applied over an operative top of the antenna, the shielding layer is configured to cover the non-through aperture, and further configured to protect the antenna from the environment, and the material used for manufacturing the shielding layer has low wireless signal attenuation.

Yet another implementation of the present disclosure is a method for providing indoor navigation. The method can be performed by a processor of a portable electronic device associated with a user and includes receiving, an indication to navigate via a user interface of a portable electronic device associated with a user, and indication to navigate includes a target location coordinates, receiving, a plurality of first wireless signals having an identification information transmitted by a plurality of first access points, and the first access points are spatially located in an indoor space which includes ceiling and walls, receiving, a plurality of second wireless signals having an identification information transmitted by a plurality of second access points, and the second access points are located under an elevated floor, and each of the second access points is associated with an antenna integrated with a tile of the elevated floor, determining, the signal strength of each of the first and second wireless signals, determining, the location coordinates of the user by evaluating the signal strength and pre-defined location coordinates of each of the first and second access points, and generating, a navigable route between the location coordinates of the user and the target location coordinates.

In some embodiments, the target location coordinates corresponds to location coordinates of an asset determined using the signal strength of first access points and the signal strength of second access points.

In some embodiments, the target location coordinates corresponds to selection of location coordinates from a floor plan of the indoor space, and the floor plan of the indoor space is pre-stored in a memory of the portable electronic device associated with the user.

In some embodiments, of evaluating the signal strength and pre-defined location coordinates of the first and second access points to determine the location coordinates of the user includes the steps of identifying, at least one first access point and at least one second access point having signal strength greater than or equal to a pre-defined threshold signal strength, analyzing, the signal strength and location coordinates of each of the identified first and second access points to determine potential coordinates of the user on the signal strength map of each of the identified first and second access points, and determining, the location coordinates of the user by overlapping the signal strength map of each of the identified first and second access points and by electing one of the potential coordinates which exists in each of the strength maps as the location coordinates, and the signal strength map of each of the first and second access points is stored in the memory of the portable electronic device.

In some embodiments, integrating the antenna with the tile of the elevated floor includes the steps of configuring, a non-through aperture on the tile, disposing, the antenna within the non-through aperture and connecting the antenna with the second access point secured on a solid substrate below the elevated floor, and providing, one or more reflective surfaces within the non-through aperture and the reflective surface is configured facilitate reflection of impinged wireless signals transmitted by the antenna towards an indoor space.

In some embodiments, integrating the antenna with the tile of the elevated floor includes the step of covering the non-through aperture by applying a shielding layer over an operative top of the antenna, and the shielding layer is configured to shield the antenna from the environment.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a building management system (BMS), according to some embodiments.

FIG. 2 is a block diagram of a BMS that serves the building of FIG. 1, according to some embodiments.

FIG. 3 is a block diagram of a BMS controller which can be used in the BMS of FIG. 2, according to some embodiments.

FIG. 4 is another block diagram of the BMS that serves the building of FIG. 1, according to some embodiments.

FIG. 5 illustrates a schematic view of an elevated floor having at least one tile with an integrated antenna that is connected to an access point, in accordance with an embodiment of the present disclosure.

FIG. 6 illustrates a schematic view of a conventional tile integrated with an antenna.

FIG. 7 illustrates a schematic view of a tile with an integrated antenna, in accordance with an embodiment of the present disclosure.

FIG. 8 illustrates a schematic view depicting the tile with an integrated antenna of FIG. 5 having a shielding layer on top of the antenna, in accordance with some embodiments.

FIG. 9 illustrates a bottom of the tile depicting an airtight seal that is configured on an outer periphery of the tile, according to some embodiments.

FIG. 10 is a flowchart of a method for integrating an antenna with a tile of an elevated floor, in accordance with some embodiments of the present disclosure.

FIG. 11 illustrates an exemplary strength-map/field of the antenna, according to some embodiments.

FIG. 12 is a block diagram of an asset localization system, in accordance with some embodiments.

FIG. 13 is block diagram of an asset and a controller of the asset localization system of FIG. 12, in accordance with one embodiment of the present disclosure.

FIG. 14 is a flowchart of a method for indoor localization of an asset, according to some embodiments.

FIG. 15 is a flowchart of a method for determining the location coordinates of the asset, in accordance with an embodiment.

FIG. 16 is a block diagram of an indoor navigation system, in accordance with an embodiment of the present disclosure.

FIG. 17 is a flowchart of a method for providing indoor navigation, according to some embodiments.

### DETAILED DESCRIPTION

### Overview

Before turning to the FIGURES, it should be understood that the disclosure is not limited to the details or methodology set forth in the description or illustrated in the figures. It should also be understood that the terminology is for the purpose of description only and should not be regarded as limiting.

Referring generally to the FIGURES, an elevated floor with integrated antennas is described. The integrated antenna may be coupled to an access point located under the elevated floor. Additionally, the present disclosure envisages employment of under raised floor mounted access points and wall/ceiling mounted access points for indoor asset localization and indoor navigation which yields improved accuracy as compared to conventional techniques which employs only above floor level mounted access points.

The present disclosure focuses on enhancing the signal strength and coverage of the integrated antennas by preventing a portion of transmitted wireless signals from getting absorbed by the walls of the tile's pocket configured to house the antenna.

### Building and Building Management System

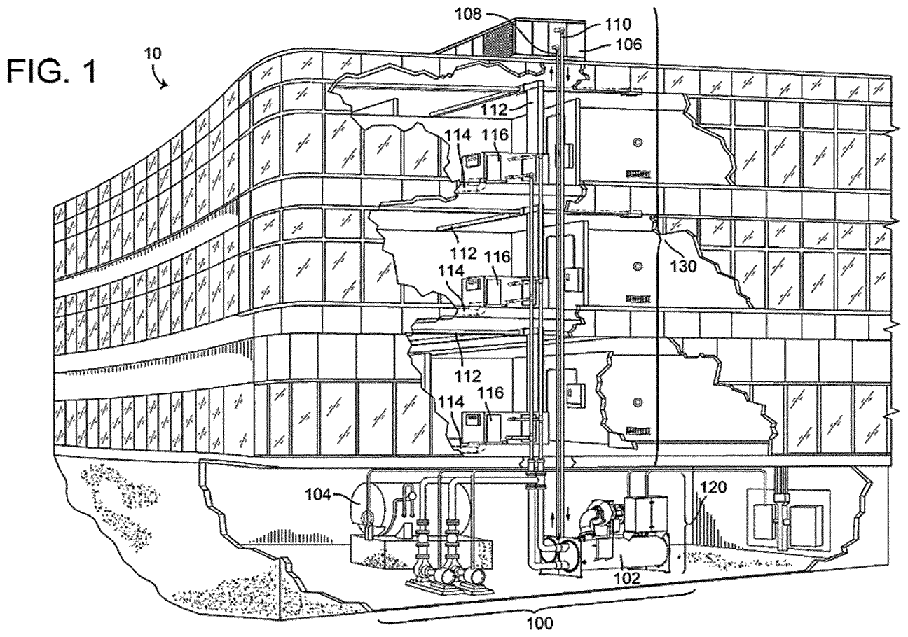

Referring now to FIG. 1, a perspective view of a building 10 is shown, according to an exemplary embodiment. A BMS serves building 10. The BMS for building 10 may include any number or type of devices that serve building 10. For example, each floor may include one or more security devices, video surveillance cameras, fire detectors, smoke detectors, lighting systems, HVAC systems, or other building systems or devices. In modern BMSs, BMS devices can exist on different networks within the building (e.g., one or more wireless networks, one or more wired networks, etc.) and yet serve the same building space or control loop. For example, BMS devices may be connected to different communications networks or field controllers even if the devices serve the same area (e.g., floor, conference room, building zone, tenant area, etc.) or purpose (e.g., security, ventilation, cooling, heating, etc.).

BMS devices may collectively or individually be referred to as building equipment. Building equipment may include any number or type of BMS devices within or around building 10. For example, building equipment may include controllers, chillers, rooftop units, fire and security systems, elevator systems, thermostats, lighting, serviceable equipment (e.g., vending machines), and/or any other type of equipment that can be used to control, automate, or otherwise contribute to an environment, state, or condition of building 10. The terms “BMS devices,” “BMS device” and “building equipment” are used interchangeably throughout this disclosure.

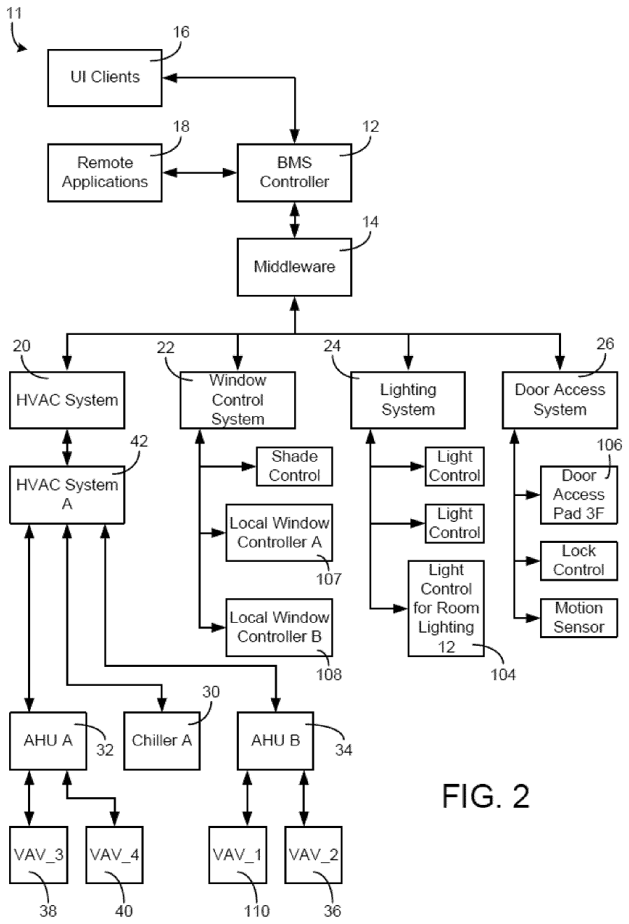

Referring now to FIG. 2, a block diagram of a BMS 11 for building 10 is shown, according to an exemplary embodiment. BMS 11 is shown to include a plurality of BMS subsystems 20-26. Each BMS subsystem 20-26 is connected to a plurality of BMS devices and makes data points for varying connected devices available to upstream BMS controller 12. Additionally, BMS subsystems 20-26 may encompass other lower-level subsystems. For example, an HVAC system may be broken down further as “HVAC system A,” “HVAC system B,” etc. In some buildings, multiple HVAC systems or subsystems may exist in parallel and may not be a part of the same HVAC system 20.

As shown in FIG. 2, BMS 11 may include a HVAC system 20. HVAC system 20 may control HVAC operations building 10. HVAC system 20 is shown to include a lower-level HVAC system 42 (named “HVAC system A”). HVAC system 42 may control HVAC operations for a specific floor or zone of building 10. HVAC system 42 may be connected to air handling units (AHUs) 32, 34 (named “AHU A” and “AHU B,” respectively, in BMS 11). AHU 32 may serve variable air volume (VAV) boxes 38, 40 (named “VAV_3” and “VAV_4” in BMS 11). Likewise, AHU 34 may serve VAV boxes 36 and 110 (named “VAV_2” and “VAV_1”). HVAC system 42 may also include chiller 30 (named “Chiller A” in BMS 11). Chiller 30 may provide chilled fluid to AHU 32 and/or to AHU 34. HVAC system 42 may receive data (i.e., BMS inputs such as temperature sensor readings, damper positions, temperature setpoints, etc.) from AHUs 32, 34. HVAC system 42 may provide such BMS inputs to HVAC system 20 and on to middleware 14 and BMS controller 12. Similarly, other BMS subsystems may receive inputs from other building devices or objects and provide the received inputs to BMS controller 12 (e.g., via middleware 14).

Middleware 14 may include services that allow interoperable communication to, from, or between disparate BMS subsystems 20-26 of BMS 11 (e.g., HVAC systems from different manufacturers, HVAC systems that communicate according to different protocols, security/fire systems, IT resources, door access systems, etc.). Middleware 14 may be, for example, an EnNet server sold by Johnson Controls, Inc. While middleware 14 is shown as separate from BMS controller 12, middleware 14 and BMS controller 12 may integrated in some embodiments. For example, middleware 14 may be a part of BMS controller 12.

Still referring to FIG. 2, window control system 22 may receive shade control information from one or more shade controls, ambient light level information from one or more light sensors, and/or other BMS inputs (e.g., sensor information, setpoint information, current state information, etc.) from downstream devices. Window control system 22 may include window controllers 107, 108 (e.g., named “local window controller A” and “local window controller B,” respectively, in BMS 11). Window controllers 107, 108 control the operation of subsets of window control system 22. For example, window controller 108 may control window blind or shade operations for a given room, floor, or building in the BMS.

Lighting system 24 may receive lighting related information from a plurality of downstream light controls (e.g., from room lighting 104). Door access system 26 may receive lock control, motion, state, or other door related information from a plurality of downstream door controls. Door access system 26 is shown to include door access pad 106 (named “Door Access Pad 3F”), which may grant or deny access to a building space (e.g., a floor, a conference room, an office, etc.) based on whether valid user credentials are scanned or entered (e.g., via a keypad, via a badge-scanning pad, etc.).

BMS subsystems 20-26 may be connected to BMS controller 12 via middleware 14 and may be configured to provide BMS controller 12 with BMS inputs from various BMS subsystems 20-26 and their varying downstream devices. BMS controller 12 may be configured to make differences in building subsystems transparent at the human-machine interface or client interface level (e.g., for connected or hosted user interface (UI) clients 16, remote applications 18, etc.). BMS controller 12 may be configured to describe or model different building devices and building subsystems using common or unified objects (e.g., software objects stored in memory) to help provide the transparency. Software equipment objects may allow developers to write applications capable of monitoring and/or controlling various types of building equipment regardless of equipment-specific variations (e.g., equipment model, equipment manufacturer, equipment version, etc.). Software building objects may allow developers to write applications capable of monitoring and/or controlling building zones on a zone-by-zone level regardless of the building subsystem makeup.

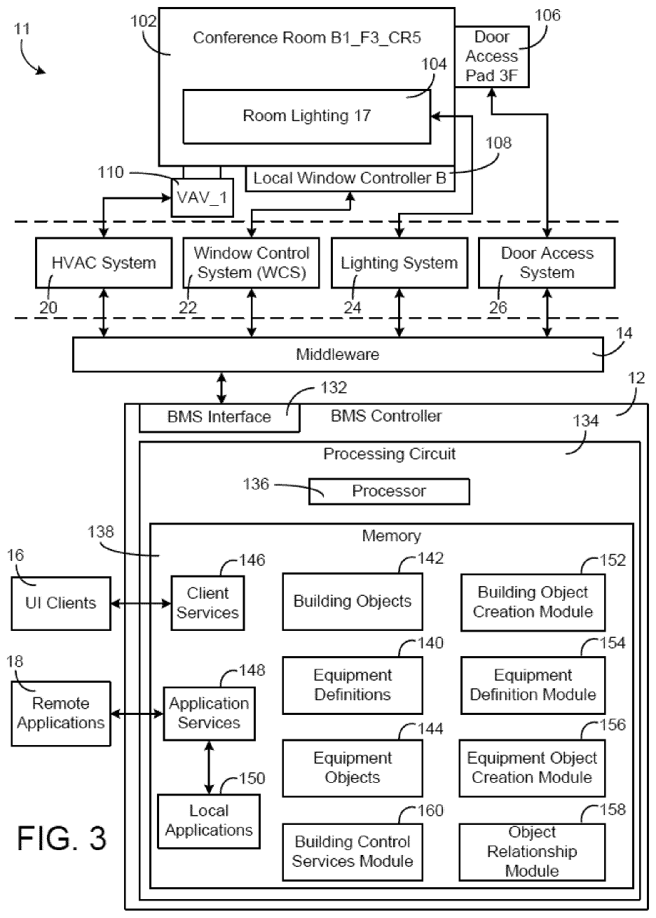

Referring now to FIG. 3, a block diagram illustrating a portion of BMS 11 in greater detail is shown, according to an exemplary embodiment. Particularly, FIG. 3 illustrates a portion of BMS 11 that services a conference room 102 of building 10 (named “B1_F3_CR5”). Conference room 102 may be affected by many different building devices connected to many different BMS subsystems. For example, conference room 102 includes or is otherwise affected by VAV box 110, window controller 108 (e.g., a blind controller), a system of lights 104 (named “Room Lighting 17”), and a door access pad 106.

Each of the building devices shown at the top of FIG. 3 may include local control circuitry configured to provide signals to their supervisory controllers or more generally to the BMS subsystems 20-26. The local control circuitry of the building devices shown at the top of FIG. 3 may also be configured to receive and respond to control signals, commands, setpoints, or other data from their supervisory controllers. For example, the local control circuitry of VAV box 110 may include circuitry that affects an actuator in response to control signals received from a field controller that is a part of HVAC system 20. Window controller 108 may include circuitry that affects windows or blinds in response to control signals received from a field controller that is part of window control system (WCS) 22. Room lighting 104 may include circuitry that affects the lighting in response to control signals received from a field controller that is part of lighting system 24. Access pad 106 may include circuitry that affects door access (e.g., locking or unlocking the door) in response to control signals received from a field controller that is part of door access system 26.

Still referring to FIG. 3, BMS controller 12 is shown to include a BMS interface 132 in communication with middleware 14. In some embodiments, BMS interface 132 is a communications interface. For example, BMS interface 132 may include wired or wireless interfaces (e.g., jacks, antennas, transmitters, receivers, transceivers, wire terminals, etc.) for conducting data communications with various systems, devices, or networks. BMS interface 132 can include an Ethernet card and port for sending and receiving data via an Ethernet-based communications network. In another example, BMS interface 132 includes a Wi-Fi transceiver for communicating via a wireless communications network. BMS interface 132 may be configured to communicate via local area networks or wide area networks (e.g., the Internet, a building WAN, etc.).

In some embodiments, BMS interface 132 and/or middleware 14 includes an application gateway configured to receive input from applications running on client devices. For example, BMS interface 132 and/or middleware 14 may include one or more wireless transceivers (e.g., a Wi-Fi transceiver, a Bluetooth transceiver, a NFC transceiver, a cellular transceiver, etc.) for communicating with client devices. BMS interface 132 may be configured to receive building management inputs from middleware 14 or directly from one or more BMS subsystems 20-26. BMS interface 132 and/or middleware 14 can include any number of software buffers, queues, listeners, filters, translators, or other communications-supporting services.

Still referring to FIG. 3, BMS controller 12 is shown to include a processing circuit 134 including a processor 136 and memory 138. Processor 136 may be a general purpose or specific purpose processor, an application specific integrated circuit (ASIC), one or more field programmable gate arrays (FPGAs), a group of processing components, or other suitable processing components. Processor 136 is configured to execute computer code or instructions stored in memory 138 or received from other computer readable media (e.g., CDROM, network storage, a remote server, etc.).

Memory 138 may include one or more devices (e.g., memory units, memory devices, storage devices, etc.) for storing data and/or computer code for completing and/or facilitating the various processes described in the present disclosure. Memory 138 may include random access memory (RAM), read-only memory (ROM), hard drive storage, temporary storage, non-volatile memory, flash memory, optical memory, or any other suitable memory for storing software objects and/or computer instructions. Memory 138 may include database components, object code components, script components, or any other type of information structure for supporting the various activities and information structures described in the present disclosure. Memory 138 may be communicably connected to processor 136 via processing circuit 134 and may include computer code for executing (e.g., by processor 136) one or more processes described herein. When processor 136 executes instructions stored in memory 138 for completing the various activities described herein, processor 136 generally configures BMS controller 12 (and more particularly processing circuit 134) to complete such activities.

Still referring to FIG. 3, memory 138 is shown to include building objects 142. In some embodiments, BMS controller 12 uses building objects 142 to group otherwise ungrouped or unassociated devices so that the group may be addressed or handled by applications together and in a consistent manner (e.g., a single user interface for controlling all of the BMS devices that affect a particular building zone or room). Building objects can apply to spaces of any granularity. For example, a building object can represent an entire building, a floor of a building, or individual rooms on each floor. In some embodiments, BMS controller 12 creates and/or stores a building object in memory 138 for each zone or room of building 10. Building objects 142 can be accessed by UI clients 16 and remote applications 18 to provide a comprehensive user interface for controlling and/or viewing information for a particular building zone. Building objects 142 may be created by building object creation module 152 and associated with equipment objects by object relationship module 158, described in greater detail below.

Still referring to FIG. 3, memory 138 is shown to include equipment definitions 140. Equipment definitions 140 stores the equipment definitions for various types of building equipment. Each equipment definition may apply to building equipment of a different type. For example, equipment definitions 140 may include different equipment definitions for variable air volume modular assemblies (VMAs), fan coil units, air handling units (AHUs), lighting fixtures, water pumps, and/or other types of building equipment.

Equipment definitions 140 define the types of data points that are generally associated with various types of building equipment. For example, an equipment definition for VMA may specify data point types such as room temperature, damper position, supply air flow, and/or other types data measured or used by the VMA. Equipment definitions 140 allow for the abstraction (e.g., generalization, normalization, broadening, etc.) of equipment data from a specific BMS device so that the equipment data can be applied to a room or space.

Each of equipment definitions 140 may include one or more point definitions. Each point definition may define a data point of a particular type and may include search criteria for automatically discovering and/or identifying data points that satisfy the point definition. An equipment definition can be applied to multiple pieces of building equipment of the same general type (e.g., multiple different VMA controllers). When an equipment definition is applied to a BMS device, the search criteria specified by the point definitions can be used to automatically identify data points provided by the BMS device that satisfy each point definition.

In some embodiments, equipment definitions 140 define data point types as generalized types of data without regard to the model, manufacturer, vendor, or other differences between building equipment of the same general type. The generalized data points defined by equipment definitions 140 allows each equipment definition to be referenced by or applied to multiple different variants of the same type of building equipment.

In some embodiments, equipment definitions 140 facilitate the presentation of data points in a consistent and user-friendly manner. For example, each equipment definition may define one or more data points that are displayed via a user interface. The displayed data points may be a subset of the data points defined by the equipment definition.

In some embodiments, equipment definitions 140 specify a system type (e.g., HVAC, lighting, security, fire, etc.), a system sub-type (e.g., terminal units, air handlers, central plants), and/or data category (e.g., critical, diagnostic, operational) associated with the building equipment defined by each equipment definition. Specifying such attributes of building equipment at the equipment definition level allows the attributes to be applied to the building equipment along with the equipment definition when the building equipment is initially defined. Building equipment can be filtered by various attributes provided in the equipment definition to facilitate the reporting and management of equipment data from multiple building systems.

Equipment definitions 140 can be automatically created by abstracting the data points provided by archetypal controllers (e.g., typical or representative controllers) for various types of building equipment. In some embodiments, equipment definitions 140 are created by equipment definition module 154, described in greater detail below.

Still referring to FIG. 3, memory 138 is shown to include equipment objects 144. Equipment objects 144 may be software objects that define a mapping between a data point type (e.g., supply air temperature, room temperature, damper position) and an actual data point (e.g., a measured or calculated value for the corresponding data point type) for various pieces of building equipment. Equipment objects 144 may facilitate the presentation of equipment-specific data points in an intuitive and user-friendly manner by associating each data point with an attribute identifying the corresponding data point type. The mapping provided by equipment objects 144 may be used to associate a particular data value measured or calculated by BMS 11 with an attribute that can be displayed via a user interface.

Equipment objects 144 can be created (e.g., by equipment object creation module 156) by referencing equipment definitions 140. For example, an equipment object can be created by applying an equipment definition to the data points provided by a BMS device. The search criteria included in an equipment definition can be used to identify data points of the building equipment that satisfy the point definitions. A data point that satisfies a point definition can be mapped to an attribute of the equipment object corresponding to the point definition.

Each equipment object may include one or more attributes defined by the point definitions of the equipment definition used to create the equipment object. For example, an equipment definition which defines the attributes “Occupied Command,” “Room Temperature,” and “Damper Position” may result in an equipment object being created with the same attributes. The search criteria provided by the equipment definition are used to identify and map data points associated with a particular BMS device to the attributes of the equipment object. The creation of equipment objects is described in greater detail below with reference to equipment object creation module 156.

Equipment objects 144 may be related with each other and/or with building objects 142. Causal relationships can be established between equipment objects to link equipment objects to each other. For example, a causal relationship can be established between a VMA and an AHU which provides airflow to the VMA. Causal relationships can also be established between equipment objects 144 and building objects 142. For example, equipment objects 144 can be associated with building objects 142 representing particular rooms or zones to indicate that the equipment object serves that room or zone. Relationships between objects are described in greater detail below with reference to object relationship module 158.

Still referring to FIG. 3, memory 138 is shown to include client services 146 and application services 148. Client services 146 may be configured to facilitate interaction and/or communication between BMS controller 12 and various internal or external clients or applications. For example, client services 146 may include web services or application programming interfaces available for communication by UI clients 16 and remote applications 18 (e.g., applications running on a mobile device, energy monitoring applications, applications allowing a user to monitor the performance of the BMS, automated fault detection and diagnostics systems, etc.). Application services 148 may facilitate direct or indirect communications between remote applications 18, local applications 150, and BMS controller 12. For example, application services 148 may allow BMS controller 12 to communicate (e.g., over a communications network) with remote applications 18 running on mobile devices and/or with other BMS controllers.

In some embodiments, application services 148 facilitate an applications gateway for conducting electronic data communications with UI clients 16 and/or remote applications 18. For example, application services 148 may be configured to receive communications from mobile devices and/or BMS devices. Client services 146 may provide client devices with a graphical user interface that consumes data points and/or display data defined by equipment definitions 140 and mapped by equipment objects 144.

Still referring to FIG. 3, memory 138 is shown to include a building object creation module 152. Building object creation module 152 may be configured to create the building objects stored in building objects 142. Building object creation module 152 may create a software building object for various spaces within building 10. Building object creation module 152 can create a building object for a space of any size or granularity. For example, building object creation module 152 can create a building object representing an entire building, a floor of a building, or individual rooms on each floor. In some embodiments, building object creation module 152 creates and/or stores a building object in memory 138 for each zone or room of building 10.

The building objects created by building object creation module 152 can be accessed by UI clients 16 and remote applications 18 to provide a comprehensive user interface for controlling and/or viewing information for a particular building zone. Building objects 142 can group otherwise ungrouped or unassociated devices so that the group may be addressed or handled by applications together and in a consistent manner (e.g., a single user interface for controlling all of the BMS devices that affect a particular building zone or room). In some embodiments, building object creation module 152 uses the systems and methods described in U.S. patent application Ser. No. 12/887,390, filed Sep. 21, 2010, for creating software defined building objects.

In some embodiments, building object creation module 152 provides a user interface for guiding a user through a process of creating building objects. For example, building object creation module 152 may provide a user interface to client devices (e.g., via client services 146) that allows a new space to be defined. In some embodiments, building object creation module 152 defines spaces hierarchically. For example, the user interface for creating building objects may prompt a user to create a space for a building, for floors within the building, and/or for rooms or zones within each floor.

In some embodiments, building object creation module 152 creates building objects automatically or semi-automatically. For example, building object creation module 152 may automatically define and create building objects using data imported from another data source (e.g., user view folders, a table, a spreadsheet, etc.). In some embodiments, building object creation module 152 references an existing hierarchy for BMS 11 to define the spaces within building 10. For example, BMS 11 may provide a listing of controllers for building 10 (e.g., as part of a network of data points) that have the physical location (e.g., room name) of the controller in the name of the controller itself. Building object creation module 152 may extract room names from the names of BMS controllers defined in the network of data points and create building objects for each extracted room. Building objects may be stored in building objects 142.

Still referring to FIG. 3, memory 138 is shown to include an equipment definition module 154. Equipment definition module 154 may be configured to create equipment definitions for various types of building equipment and to store the equipment definitions in equipment definitions 140. In some embodiments, equipment definition module 154 creates equipment definitions by abstracting the data points provided by archetypal controllers (e.g., typical or representative controllers) for various types of building equipment. For example, equipment definition module 154 may receive a user selection of an archetypal controller via a user interface. The archetypal controller may be specified as a user input or selected automatically by equipment definition module 154. In some embodiments, equipment definition module 154 selects an archetypal controller for building equipment associated with a terminal unit such as a VMA.

Equipment definition module 154 may identify one or more data points associated with the archetypal controller. Identifying one or more data points associated with the archetypal controller may include accessing a network of data points provided by BMS 11. The network of data points may be a hierarchical representation of data points that are measured, calculated, or otherwise obtained by various BMS devices. BMS devices may be represented in the network of data points as nodes of the hierarchical representation with associated data points depending from each BMS device. Equipment definition module 154 may find the node corresponding to the archetypal controller in the network of data points and identify one or more data points which depend from the archetypal controller node.

Equipment definition module 154 may generate a point definition for each identified data point of the archetypal controller. Each point definition may include an abstraction of the corresponding data point that is applicable to multiple different controllers for the same type of building equipment. For example, an archetypal controller for a particular VMA (i.e., “VMA-20”) may be associated an equipment-specific data point such as “VMA-20.DPR-POS” (i.e., the damper position of VMA-20) and/or “VMA-20.SUP-FLOW” (i.e., the supply air flow rate through VMA-20). Equipment definition module 154 abstract the equipment-specific data points to generate abstracted data point types that are generally applicable to other equipment of the same type. For example, equipment definition module 154 may abstract the equipment-specific data point “VMA-20.DPR-POS” to generate the abstracted data point type “DPR-POS” and may abstract the equipment-specific data point “VMA-20.SUP-FLOW” to generate the abstracted data point type “SUP-FLOW.” Advantageously, the abstracted data point types generated by equipment definition module 154 can be applied to multiple different variants of the same type of building equipment (e.g., VMAs from different manufacturers, VMAs having different models or output data formats, etc.).

In some embodiments, equipment definition module 154 generates a user-friendly label for each point definition. The user-friendly label may be a plain text description of the variable defined by the point definition. For example, equipment definition module 154 may generate the label “Supply Air Flow” for the point definition corresponding to the abstracted data point type “SUP-FLOW” to indicate that the data point represents a supply air flow rate through the VMA. The labels generated by equipment definition module 154 may be displayed in conjunction with data values from BMS devices as part of a user-friendly interface.

In some embodiments, equipment definition module 154 generates search criteria for each point definition. The search criteria may include one or more parameters for identifying another data point (e.g., a data point associated with another controller of BMS 11 for the same type of building equipment) that represents the same variable as the point definition. Search criteria may include, for example, an instance number of the data point, a network address of the data point, and/or a network point type of the data point.

In some embodiments, search criteria include a text string abstracted from a data point associated with the archetypal controller. For example, equipment definition module 154 may generate the abstracted text string “SUP-FLOW” from the equipment-specific data point “VMA-20.SUP-FLOW.” Advantageously, the abstracted text string matches other equipment-specific data points corresponding to the supply air flow rates of other BMS devices (e.g., “VMA-18.SUP-FLOW,” “SUP-FLOW.VMA-01,” etc.). Equipment definition module 154 may store a name, label, and/or search criteria for each point definition in memory 138.

Equipment definition module 154 may use the generated point definitions to create an equipment definition for a particular type of building equipment (e.g., the same type of building equipment associated with the archetypal controller). The equipment definition may include one or more of the generated point definitions. Each point definition defines a potential attribute of BMS devices of the particular type and provides search criteria for identifying the attribute among other data points provided by such BMS devices.

In some embodiments, the equipment definition created by equipment definition module 154 includes an indication of display data for BMS devices that reference the equipment definition. Display data may define one or more data points of the BMS device that will be displayed via a user interface. In some embodiments, display data are user defined. For example, equipment definition module 154 may prompt a user to select one or more of the point definitions included in the equipment definition to be represented in the display data. Display data may include the user-friendly label (e.g., “Damper Position”) and/or short name (e.g., “DPR-POS”) associated with the selected point definitions.

In some embodiments, equipment definition module 154 provides a visualization of the equipment definition via a graphical user interface. The visualization of the equipment definition may include a point definition portion which displays the generated point definitions, a user input portion configured to receive a user selection of one or more of the point definitions displayed in the point definition portion, and/or a display data portion which includes an indication of an abstracted data point corresponding to each of the point definitions selected via the user input portion. The visualization of the equipment definition can be used to add, remove, or change point definitions and/or display data associated with the equipment definitions.

Equipment definition module 154 may generate an equipment definition for each different type of building equipment in BMS 11 (e.g., VMAs, chillers, AHUs, etc.). Equipment definition module 154 may store the equipment definitions in a data storage device (e.g., memory 138, equipment definitions 140, an external or remote data storage device, etc.).

Still referring to FIG. 3, memory 138 is shown to include an equipment object creation module 156. Equipment object creation module 156 may be configured to create equipment objects for various BMS devices. In some embodiments, equipment object creation module 156 creates an equipment object by applying an equipment definition to the data points provided by a BMS device. For example, equipment object creation module 156 may receive an equipment definition created by equipment definition module 154. Receiving an equipment definition may include loading or retrieving the equipment definition from a data storage device.

In some embodiments, equipment object creation module 156 determines which of a plurality of equipment definitions to retrieve based on the type of BMS device used to create the equipment object. For example, if the BMS device is a VMA, equipment object creation module 156 may retrieve the equipment definition for VMAs; whereas if the BMS device is a chiller, equipment object creation module 156 may retrieve the equipment definition for chillers. The type of BMS device to which an equipment definition applies may be stored as an attribute of the equipment definition. Equipment object creation module 156 may identify the type of BMS device being used to create the equipment object and retrieve the corresponding equipment definition from the data storage device.

In other embodiments, equipment object creation module 156 receives an equipment definition prior to selecting a BMS device. Equipment object creation module 156 may identify a BMS device of BMS 11 to which the equipment definition applies. For example, equipment object creation module 156 may identify a BMS device that is of the same type of building equipment as the archetypal BMS device used to generate the equipment definition. In various embodiments, the BMS device used to generate the equipment object may be selected automatically (e.g., by equipment object creation module 156), manually (e.g., by a user) or semi-automatically (e.g., by a user in response to an automated prompt from equipment object creation module 156).

In some embodiments, equipment object creation module 156 creates an equipment discovery table based on the equipment definition. For example, equipment object creation module 156 may create an equipment discovery table having attributes (e.g., columns) corresponding to the variables defined by the equipment definition (e.g., a damper position attribute, a supply air flow rate attribute, etc.). Each column of the equipment discovery table may correspond to a point definition of the equipment definition. The equipment discovery table may have columns that are categorically defined (e.g., representing defined variables) but not yet mapped to any particular data points.

Equipment object creation module 156 may use the equipment definition to automatically identify one or more data points of the selected BMS device to map to the columns of the equipment discovery table. Equipment object creation module 156 may search for data points of the BMS device that satisfy one or more of the point definitions included in the equipment definition. In some embodiments, equipment object creation module 156 extracts a search criterion from each point definition of the equipment definition. Equipment object creation module 156 may access a data point network of the building automation system to identify one or more data points associated with the selected BMS device. Equipment object creation module 156 may use the extracted search criterion to determine which of the identified data points satisfy one or more of the point definitions.

In some embodiments, equipment object creation module 156 automatically maps (e.g., links, associates, relates, etc.) the identified data points of selected BMS device to the equipment discovery table. A data point of the selected BMS device may be mapped to a column of the equipment discovery table in response to a determination by equipment object creation module 156 that the data point satisfies the point definition (e.g., the search criteria) used to generate the column. For example, if a data point of the selected BMS device has the name “VMA-18.SUP-FLOW” and a search criterion is the text string “SUP-FLOW,” equipment object creation module 156 may determine that the search criterion is met. Accordingly, equipment object creation module 156 may map the data point of the selected BMS device to the corresponding column of the equipment discovery table.

Advantageously, equipment object creation module 156 may create multiple equipment objects and map data points to attributes of the created equipment objects in an automated fashion (e.g., without human intervention, with minimal human intervention, etc.). The search criteria provided by the equipment definition facilitates the automatic discovery and identification of data points for a plurality of equipment object attributes. Equipment object creation module 156 may label each attribute of the created equipment objects with a device-independent label derived from the equipment definition used to create the equipment object. The equipment objects created by equipment object creation module 156 can be viewed (e.g., via a user interface) and/or interpreted by data consumers in a consistent and intuitive manner regardless of device-specific differences between BMS devices of the same general type. The equipment objects created by equipment object creation module 156 may be stored in equipment objects 144.

Still referring to FIG. 3, memory 138 is shown to include an object relationship module 158. Object relationship module 158 may be configured to establish relationships between equipment objects 144. In some embodiments, object relationship module 158 establishes causal relationships between equipment objects 144 based on the ability of one BMS device to affect another BMS device. For example, object relationship module 158 may establish a causal relationship between a terminal unit (e.g., a VMA) and an upstream unit (e.g., an AHU, a chiller, etc.) which affects an input provided to the terminal unit (e.g., air flow rate, air temperature, etc.).

Object relationship module 158 may establish relationships between equipment objects 144 and building objects 142 (e.g., spaces). For example, object relationship module 158 may associate equipment objects 144 with building objects 142 representing particular rooms or zones to indicate that the equipment object serves that room or zone. In some embodiments, object relationship module 158 provides a user interface through which a user can define relationships between equipment objects 144 and building objects 142. For example, a user can assign relationships in a “drag and drop” fashion by dragging and dropping a building object and/or an equipment object into a “serving” cell of an equipment object provided via the user interface to indicate that the BMS device represented by the equipment object serves a particular space or BMS device.

Still referring to FIG. 3, memory 138 is shown to include a building control services module 160. Building control services module 160 may be configured to automatically control BMS 11 and the various subsystems thereof. Building control services module 160 may utilize closed loop control, feedback control, PI control, model predictive control, or any other type of automated building control methodology to control the environment (e.g., a variable state or condition) within building 10.

Building control services module 160 may receive inputs from sensory devices (e.g., temperature sensors, pressure sensors, flow rate sensors, humidity sensors, electric current sensors, cameras, wireless sensors, microphones, etc.), user input devices (e.g., computer terminals, client devices, user devices, etc.) or other data input devices via BMS interface 132. Building control services module 160 may apply the various inputs to a building energy use model and/or a control algorithm to determine an output for one or more building control devices (e.g., dampers, air handling units, chillers, boilers, fans, pumps, etc.) in order to affect a variable state or condition within building 10 (e.g., zone temperature, humidity, air flow rate, etc.).

In some embodiments, building control services module 160 is configured to control the environment of building 10 on a zone-individualized level. For example, building control services module 160 may control the environment of two or more different building zones using different setpoints, different constraints, different control methodology, and/or different control parameters. Building control services module 160 may operate BMS 11 to maintain building conditions (e.g., temperature, humidity, air quality, etc.) within a setpoint range, to optimize energy performance (e.g., to minimize energy consumption, to minimize energy cost, etc.), and/or to satisfy any constraint or combination of constraints as may be desirable for various implementations.

In some embodiments, building control services module 160 uses the location of various BMS devices to translate an input received from a building system into an output or control signal for the building system. Building control services module 160 may receive location information for BMS devices and automatically set or recommend control parameters for the BMS devices based on the locations of the BMS devices. For example, building control services module 160 may automatically set a flow rate setpoint for a VAV box based on the size of the building zone in which the VAV box is located.

Building control services module 160 may determine which of a plurality of sensors to use in conjunction with a feedback control loop based on the locations of the sensors within building 10. For example, building control services module 160 may use a signal from a temperature sensor located in a building zone as a feedback signal for controlling the temperature of the building zone in which the temperature sensor is located.

In some embodiments, building control services module 160 automatically generates control algorithms for a controller or a building zone based on the location of the zone in the building 10. For example, building control services module 160 may be configured to predict a change in demand resulting from sunlight entering through windows based on the orientation of the building and the locations of the building zones (e.g., east-facing, west-facing, perimeter zones, interior zones, etc.).

Building control services module 160 may use zone location information and interactions between adjacent building zones (rather than considering each zone as an isolated system) to more efficiently control the temperature and/or airflow within building 10. For control loops that are conducted at a larger scale (i.e., floor level) building control services module 160 may use the location of each building zone and/or BMS device to coordinate control functionality between building zones. For example, building control services module 160 may consider heat exchange and/or air exchange between adjacent building zones as a factor in determining an output control signal for the building zones.

In some embodiments, building control services module 160 is configured to optimize the energy efficiency of building 10 using the locations of various BMS devices and the control parameters associated therewith. Building control services module 160 may be configured to achieve control setpoints using building equipment with a relatively lower energy cost (e.g., by causing airflow between connected building zones) in order to reduce the loading on building equipment with a relatively higher energy cost (e.g., chillers and roof top units). For example, building control services module 160 may be configured to move warmer air from higher elevation zones to lower elevation zones by establishing pressure gradients between connected building zones.

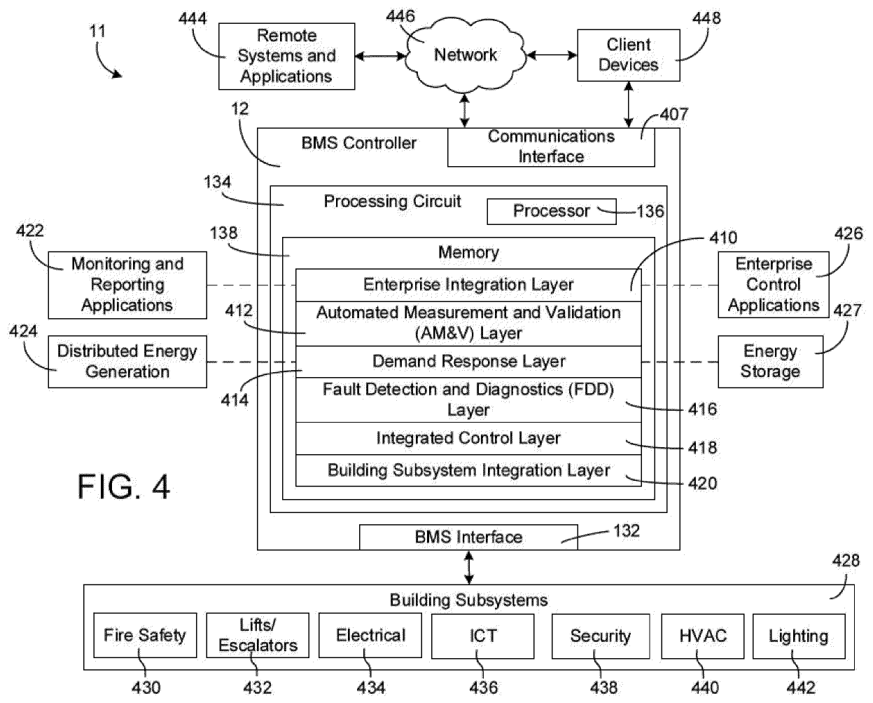

Referring now to FIG. 4, another block diagram illustrating a portion of BMS 11 in greater detail is shown, according to some embodiments. BMS 11 can be implemented in building 10 to automatically monitor and control various building functions. BMS 11 is shown to include BMS controller 12 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10.

Each of building subsystems 428 can include any number of devices, controllers, and connections for completing its individual functions and control activities. HVAC subsystem 440 can include many of the same components as HVAC system 20, as described with reference to FIGS. 2-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 12 is shown to include a communications interface 407 and a BMS interface 132. Interface 407 may facilitate communications between BMS controller 12 and external applications (e.g., monitoring and reporting applications 422, enterprise control applications 426, remote systems and applications 444, applications residing on client devices 448, etc.) for allowing user control, monitoring, and adjustment to BMS controller 12 and/or subsystems 428. Interface 407 may also facilitate communications between BMS controller 12 and client devices 448. BMS interface 132 may facilitate communications between BMS controller 12 and building subsystems 428 (e.g., HVAC, lighting security, lifts, power distribution, business, etc.).

Interfaces 407, 132 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 132 can be direct (e.g., local wired or wireless communications) or via a communications network 446 (e.g., a WAN, the Internet, a cellular network, etc.). For example, interfaces 407, 132 can include an Ethernet card and port for sending and receiving data via an Ethernet-based communications link or network. In another example, interfaces 407, 132 can include a Wi-Fi transceiver for communicating via a wireless communications network. In another example, one or both of interfaces 407, 132 can include cellular or mobile phone communications transceivers. In one embodiment, communications interface 407 is a power line communications interface and BMS interface 132 is an Ethernet interface. In other embodiments, both communications interface 407 and BMS interface 132 are Ethernet interfaces or are the same Ethernet interface.

Still referring to FIG. 4, BMS controller 12 is shown to include a processing circuit 134 including a processor 136 and memory 138. Processing circuit 134 can be communicably connected to BMS interface 132 and/or communications interface 407 such that processing circuit 134 and the various components thereof can send and receive data via interfaces 407, 132. Processor 136 can be implemented as a general purpose processor, an application specific integrated circuit (ASIC), one or more field programmable gate arrays (FPGAs), a group of processing components, or other suitable electronic processing components.

Memory 138 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 138 can be or include volatile memory or non-volatile memory. Memory 138 can include database components, object code components, script components, or any other type of information structure for supporting the various activities and information structures described in the present application. According to some embodiments, memory 138 is communicably connected to processor 136 via processing circuit 134 and includes computer code for executing (e.g., by processing circuit 134 and/or processor 136) one or more processes described herein.

In some embodiments, BMS controller 12 is implemented within a single computer (e.g., one server, one housing, etc.). In various other embodiments BMS controller 12 can be distributed across multiple servers or computers (e.g., that can exist in distributed locations). Further, while FIG. 4 shows applications 422 and 426 as existing outside of BMS controller 12, in some embodiments, applications 422 and 426 can be hosted within BMS controller 12 (e.g., within memory 138).

Still referring to FIG. 4, memory 138 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 11.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 12. In yet other embodiments, enterprise control applications 426 can work with layers 410-420 to optimize building performance (e.g., efficiency, energy use, comfort, or safety) based on inputs received at interface 407 and/or BMS interface 132.

Building subsystem integration layer 420 can be configured to manage communications between BMS controller 12 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427, or from other sources. Demand response layer 414 may receive inputs from other layers of BMS controller 12 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 11 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Elevated Floor with Integrated Antennas

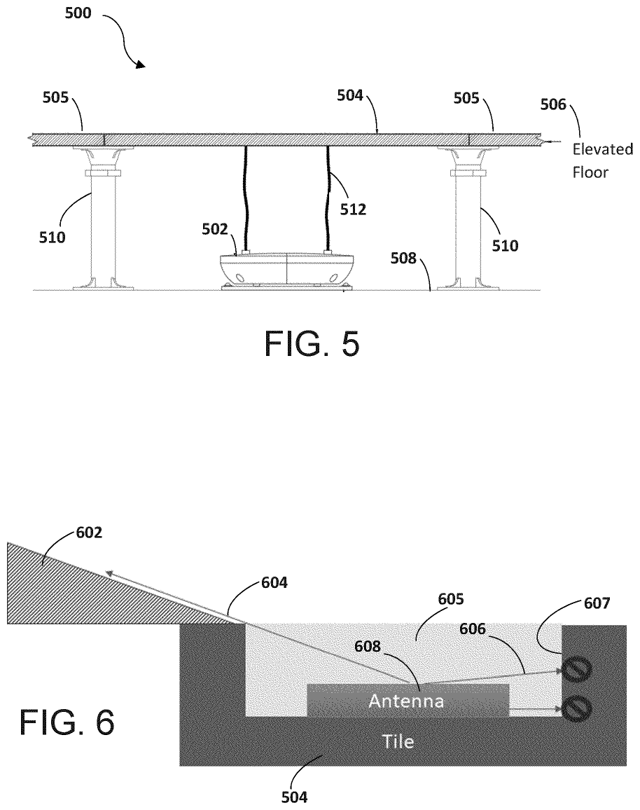

Referring now to FIG. 5, a tile 504 integrated with an antenna (not specifically shown in the figure) that is connected with an access point 502 is shown. In one embodiment, the access point 502 may be an under raised floor access point, i.e., positioned below the elevated floor 506. The access point 502 may be secured to a solid substrate 508. In some embodiments, the solid substrate 508 may be a concrete slab. In an exemplary embodiment, the solid substrate 508 may represent any solid platform that is configured and positioned below the elevated floor 506 and above the concrete slab.

The elevated floor 506 is defined by a plurality of tiles (504, 505) that are supported on a plurality of columns 510 extending from the solid substrate 508. In accordance with the present disclosure, a pocket is configured on the tile 504, where the pocket refers to a non-through aperture 605.

Referring to FIG. 6, the tile 504 with an integrated antenna 608 is shown. Specifically, FIG. 6 corresponds to a conventional arrangement of tile 504 integrated with the antenna 608. As depicted from FIG. 6, the antenna 608 may be configured to transmit the wireless signals (604, 606). As shown, however, walls 607, defined by the non-through aperture 605, tend to absorb/block a portion of transmitted wireless signals 606 that collide with the surface of the walls 607. Additionally, as depicted from FIG. 6, the performance of the antenna 608 may depend on the strength and coverage of the wireless signals 604 that exits the non-through aperture 605. However, the profile of the non-through aperture 605 and position of the antenna 608 results in formation of a shadow region 602 which is not desired, where the shadow region 602 may be formed proximal to the surface of the elevated floor 506 extending from the tiles 505, that are adjacent to the tile 504. In an embodiment, the wireless signals transmitted by the antenna 608 may refer to radio frequency (RF) signals. In another embodiment, the wireless signals transmitted by the antenna 608 may be Bluetooth low energy (BLE) signals.

Typically, concrete, metal, or any other suitable dense material may be the material of the walls 607, the wireless signals colliding with the walls 607 gets absorbed or blocked resulting in shadow effect. The region where shadow effect may be created is referred as the shadow region 602 where no wireless signal is available. This significantly limits the performance, i.e., signal strength and coverage area of the traditional elevated floor with integrated antennas design.

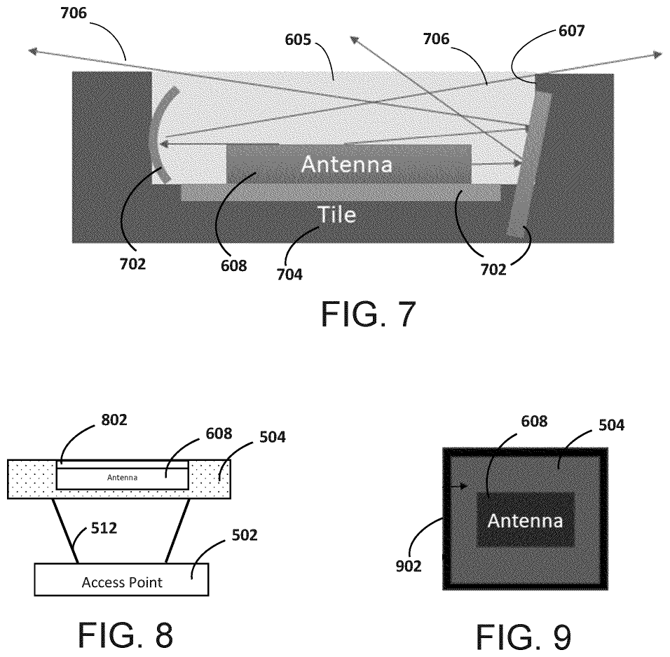

Referring to FIGS. 7-10, in accordance with some embodiments of the present disclosure, the arrangement for integrating an antenna 608 with a tile 704 may include a process of forming a non-through aperture 605 defining a pocket having walls 607. Subsequently, providing one or more reflective surfaces 702 within the non-through aperture 605. In an exemplary embodiment, the shape of one or more reflective surfaces may be selected from circle, oval, ellipse, curve, wave, spiral, bubble, cone, ring, cross, triangle, square, rectangle, hexagon, octagon, crescent, or any other geometrical and non-geometrical shape. In an embodiment, one or more reflective surfaces 702 are attached to an inner surface of the non-through aperture 605. In an alternate embodiment, the inner surface of the non-through aperture 605 is configured to function as a reflective surface, where the inner surface of the non-through aperture 605 is made from a reflective material. In some embodiments, the inner surface on which one or more reflective surfaces 702 are provided may correspond to the surface of either one of or combination of walls 607 and base of the non-through aperture 605.

The process of integrating the antenna 608 with the tile 704 further includes the step of disposing the antenna 608 within the non-through aperture 605, where the antenna 608 may be connected to the access point 502 (shown in FIG. 5) which may be an under raised floor access point, i.e., positioned below the elevated floor 506. In an embodiment, the access point 502 and the antenna 608 may be connected by means of one or more cables 512. The antenna 608 is configured to transmit the wireless signals, where a portion of the transmitted wireless signals directly exit through the opening of the non-through aperture 605 and enter a space defined above the elevated floor and whereas remaining portion of the transmitted wireless signals 706 impinge on one or more reflective surfaces 702, and are reflected towards the space above the elevated floor 506. The employment of reflective surfaces 702 enhance the signal strength and coverage of the antenna 608. Additionally, the reflective surfaces 702 prevent the wireless signals from getting absorbed/blocked by the walls 607 of the non-through aperture 605 thereby minimizing the shadow region 602 of FIG. 6. In an alternative embodiment, the antenna 608 may be disposed within the non-through aperture 605 before attaching or configuring the reflective surfaces 702 on the walls 607.

In some embodiments, at least one hole (not specifically shown in the figures) may be configured on the tile 504 to facilitate passage of the cables 512 therethough. In one implementation, the hole may be configured on an operative bottom portion of the tile 504, i.e., the hole may extend from the base of the non-through aperture 605.

In some embodiments, a shielding layer 802 may be configured over an operative top portion of the antenna 608. The shielding layer 802 may protect the antenna 608 from the environment. Specifically, the shielding layer 802 is made from the material having low wireless signal attenuation. In one implementation, the shielding layer 802 may be configured around the antenna 608 so as to completely fill the non-through aperture 605. Typically, it is desired that the depth of the non-through aperture 605 be greater than the height of the antenna 608 to accommodate shielding layer 802 for protecting the antenna 608 and the bearing the load. In an embodiment, in order to bear a heavy load, the non-through aperture 605 may be required to have a deep and small opening.

In some embodiments, an airtight seal 902 is configured on the tile 704. Specifically, the airtight seal 902 may be configured on an outer periphery of the tile 704. The airtight seal 902 may be configured to prevent formation of one or more gaps between the tile (704) and the adjacent tiles 505 of the elevated floor 506. The formation of gap(s) between the tile (704, 504) and the adjacent tiles 505 may result in leakage of air from underfloor air distribution plenums.

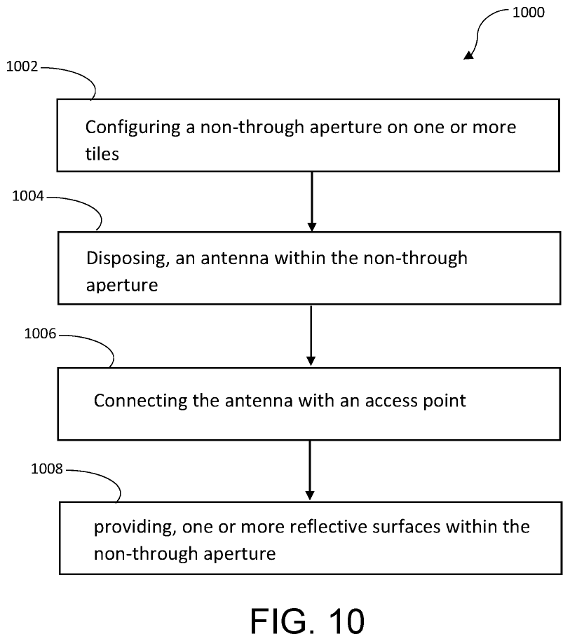

In accordance with an embodiment of the present disclosure, FIG. 10 illustrates a flowchart depicting a method 1000 for integrating an antenna with a tile of an elevated floor. The method includes the step of configuring a non-through aperture (Step 1002). In an embodiment, the step of configuring the non-through aperture may be performed by any known techniques. The profile of the non-through aperture is preferably like a pocket. In some embodiments, the profile of the non-through aperture may be circular, rectangular, oval, and the like. Further, the method 1000 is shown to include the step of disposing (at Step 1004) an antenna within the non-through aperture. In some embodiments, the depth of the non-through aperture is more than the height of the antenna housed within the non-through aperture. In an embodiment, the antenna may be positioned at the center of the non-through aperture, however the position of the antenna may not be restricted to the center of the non-through aperture and may be selected based on application specific requirements. The method 1000 is further shown to include connecting (at step 1006) the antenna with an access point secured on a solid surface below the elevated floor. In some embodiments, the antenna may be connected with the access point by means of a wired connection. In order to facilitate wired connection between the antenna and the access point, at least one hole may be configured on the tile to facilitate passage of the cable or other suitable connecting medium.

Subsequently, the method 1000 is shown to include the step of providing one or more reflective surfaces (at step 1008) within the non-through aperture. In an embodiment, two or more reflective surfaces are attached to the inner surface of the non-through aperture, and are configured to facilitate reflection of wireless signals that are transmitted by the antenna housed within the non-through aperture. In one embodiment, the inner surface of the non-through aperture is configured as one or more reflective surface, where the material of the inner surface is a reflective material. In some embodiments, one or more reflective surfaces may be attached to or configured on the base or the walls of the non-through aperture. In another embodiment, one or more reflective surfaces may be attached to or configured on both base and walls of the non-through aperture.

The elevated floor 506 having at least one tile (e.g., tile 504) integrated with an antenna 608 is enabled to minimize the shadow effect, and therefore the shadow region, by employing one or more reflective surfaces. In contrast, in a conventional raised floor with an integrated antenna a portion of transmitted signals are absorbed by the walls of the pocket, affecting the signal strength and the coverage of the integrated antenna.

### Indoor Asset Localization

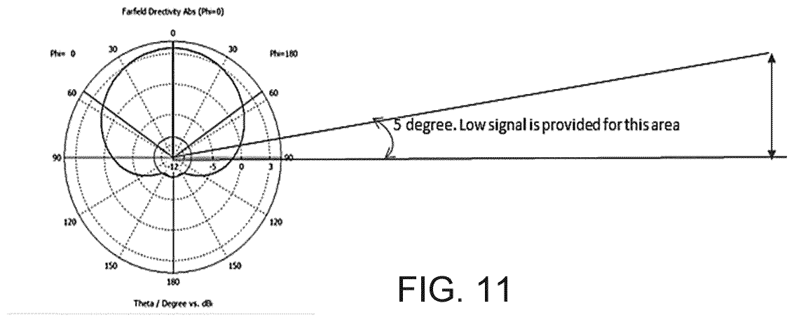

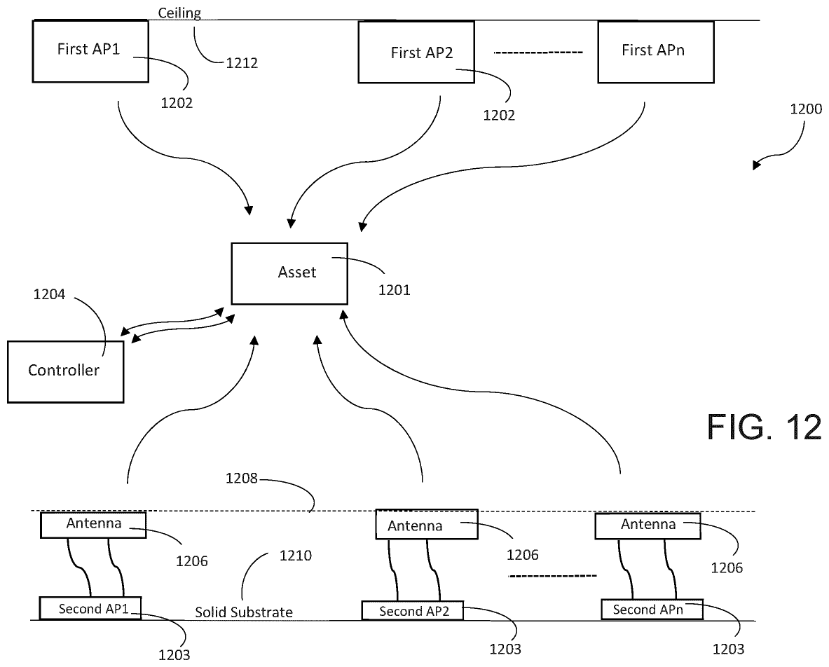

FIG. 11 illustrates an exemplary strength-map/field of the antenna, according to some embodiments. The signal strength map of the antenna depends of the multiple factors such as their position. In one implementation of the present disclosure, the signal strength and the location of the antennas are utilized to identify the location of assets.

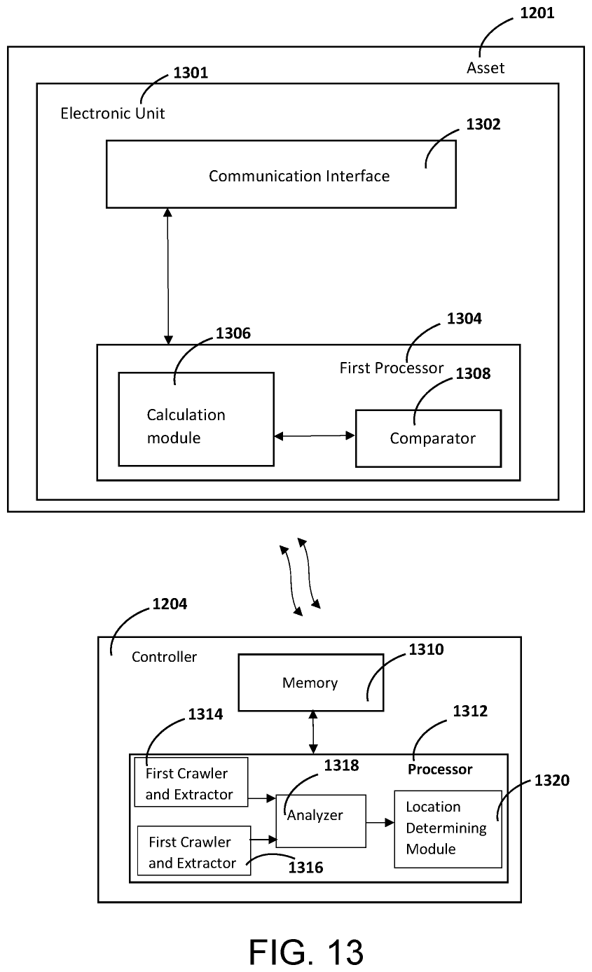

Referring to FIGS. 12 and 13, an indoor asset localization system 1200 is shown. The indoor asset localization system 1200 may include a plurality of first access points 1202, a plurality of second access points 1203, and a plurality of assets, including a first asset 1201. In some embodiments, each of the assets (e.g., asset 1201) includes an electronic unit 1301 and may be communicably coupled to a controller 1204. In some embodiments, the controller 1204 may be the controller of the building management system (BMS) as described in aforementioned description.

In an embodiment, the first access points 1202 may correspond to access points mounted on either ceiling 1212 or wall(s) of an indoor space. In an embodiment, each of the first access points 1202 is associated with an antenna (not specifically shown in the figures). The first access points 1202 are configured to transmit first wireless signals within the indoor space via the antenna. The first wireless signal transmitted by each of the first access points 1202 includes an identification information, where the identification information may include a unique identifier of the associated first access point.

In another embodiment, the second access points 1203 may correspond to under raised floor access points, and are secured on a solid substrate 1210. In this implementation, each of the second access points 1203 is associated with an antenna 1206 respectively. The antenna 1206 is integrated with a tile of an elevated floor 1208, where a non-through aperture is configured on the tile to house the antenna 1206. The second access points 1203 are configured to transmit second wireless signals within the indoor space via the antenna 1206. The second wireless signals transmitted by each of the second access points 1203 includes an identification information, where the identification information may include a unique identifier of the associated second access point. Additionally, one or more reflective surfaces are configured on or attached to the inner surface of the non-through aperture to facilitate reflection of the portion of second wireless signals emitted by the antenna 1206 and impinging on the reflective surfaces towards the indoor space. Further, in some embodiments, a shielding layer may be configured over the antenna to cover the non-through aperture, and protect the antenna from the environment. The material selected for shielding layer may have a low wireless signal attenuation.

In an embodiment, the electronic unit 1301 associated with each of the assets (e.g., asset 1201) includes a communication interface 1302 and a first processor 1304. The communication interface 1302 may facilitate communication of asset 1201 with the controller 1204, the plurality of first access points 1202, and the plurality of second access points 1203. The communication interface 1302 may be configured to receive the plurality of first and second wireless signals.

The communication interface 1302 can be or include wired or wireless communications interfaces (e.g., jacks, antennas, transmitters, receivers, transceivers, wire terminals, etc.) for conducting data communications with the controller 1204. In various embodiments, communications via communication interface 1302 can be direct (e.g., local wired or wireless communications) or via a communications network (e.g., a WAN, the Internet, a cellular network, etc.). For example, communication interface 1302 can include an Ethernet card and port for sending and receiving data via an Ethernet-based communications link or network. In another example, the communication interface 1302 can include a Wi-Fi transceiver for communicating via a wireless communications network. In another example, the communication interface 1302 can include cellular or mobile phone communications transceivers.

The first processor 1304 may be configured to receive the plurality of first wireless signals and the plurality of second wireless signals from the communication interface 1302. The first processor 1304 is enabled to determine the signal strength of each of the first access points 1202 and each of the second access points 1203 based on the received first and second wireless signals. Further, the first processor 1304 may be configured to tag the determined signal strength of each of the first access points 1202 and the second access points 1203 with their respective identification information, i.e. identifiers. Subsequently, the first processor 1304 may be configured to identify at least one of the first access points 1202 and at least one second access points 1203 having determined signal strength greater than or equal to a pre-defined threshold signal strength. In an embodiment, the pre-defined threshold signal strength may be stored within a memory of the electronic unit 1301. In another embodiment, the pre-defined signal strength may be different for the first access points 1202 and the second access points 1203.

In an embodiment, the first processor 1304 can be implemented as a general purpose processor, an application specific integrated circuit (ASIC), one or more field programmable gate arrays (FPGAs), a group of processing components, or other suitable electronic processing components.

In some embodiments, the first processor 1304 includes a calculation module 1306 and a comparator 1308. The calculation module 1306 is enabled to determine the signal strength of each of the first access points 1202 and the second access points 1203 based on their respective wireless signals. In some embodiments, the calculation module 1306 may be configured to determine the signal strength based on pre-determined calculation techniques. The comparator 1308 may be configured to cooperate with the calculation module 1306 to receive the signal strength of each of the first access points 1202 and second access points 1203, and may be further enabled to compare the signal strength of each of the first access points 1202 and second access points 1203 with the pre-defined threshold, where the access points (1202, 1203) having signal strength greater than the pre-defined threshold is identified.

Furthermore, the signal strength and the identification information of the identified or selected first or second access point(s) (1202, 1203) are transmitted to the controller 1204, via the communication interface 1302. In some embodiments, the controller 1204 is remotely located with respect to the asset 1201. In various embodiment, the controller 1204 may correspond to a controller of a remote server or station.

The controller 1204 may include a memory 1310 and a processor 1312. The memory 1310 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 1310 can be or include volatile memory or non-volatile memory. Memory 1310 can include database components, object code components, script components, or any other type of information structure for supporting the various activities and information structures described in the present application. According to some embodiments, memory 1310 is communicably connected to processor 1312 and includes computer code for executing (e.g., by the controller 1204 and/or processor 1312) one or more processes described herein. The Processor 1312 can be implemented as a general purpose processor, an application specific integrated circuit (ASIC), one or more field programmable gate arrays (FPGAs), a group of processing components, or other suitable electronic processing components.

In an embodiment, the memory 1310 may be configured to store a first lookup table, a second lookup table, and a signal strength map corresponding to each of the first access points 1202 and the second access points 1203. The first lookup table may comprise a list of first access points 1202, and the identification information and location coordinates corresponding to each of the first access points 1202. The second lookup table may comprise a list of second access points 1203, and the identification information and location coordinates corresponding to each of the second access points 1203.

In some embodiments, the processor 1312 is configured to cooperate with the memory 1310, and may comprise a first crawler and extractor 1314, a second crawler and extractor 1316, an analyzer 1318, and a location determining module 1320. The first crawler and extractor 1314 may be configured to receive the identification information corresponding to each of the identified first access points, and may be further configured to crawl through (i.e., analyze) the first lookup table to extract (i.e., identify) the location coordinates of each of the identified first access points 1202 corresponding to the received identification information of the identified first access points 1202. Similarly, the second crawler and extractor 1316 may be configured to receive the identification information corresponding to each of the identified second access points 1203, and may be further configured to crawl through the second lookup table to extract the location coordinates of each of the identified second access points 1203 corresponding to the received identification information of the identified second access points 1203.

The analyzer 1318 may be configured to cooperate with the first crawler and extractor 1314 and the second crawler and extractor 1316 to receive the location coordinates of the identified first access points 1202 and the location coordinates of the identified second access points 1203, respectively. The analyzer 1318 may also be configured to analyze the signal strength and location coordinates of each of the identified first and second access points (1202, 1203) to determine potential coordinates of the asset 1201 on the signal strength map of each of the identified first and second access points (1202, 1203).

In an embodiment, the potential coordinates of the asset 1201 may correspond to the possible coordinates based on the field of the antenna of the first and second access points (1202, 1203). Typically, the potential coordinates in the signal strength map of each of the identified first and second access points may correspond to one or more quadrants. In some embodiments, the location determining module 1320 may cooperate with the analyzer 1318 to receive the signal strength map having potential coordinates of each of the identified first and second access points. Further, the location determining module 1320 may be configured to elect one of the potential coordinates as the location coordinates. In an embodiment, the location determining module 1320 may be configured to elect one of the potential coordinates as the location coordinates by overlapping the signal strength map of each of the identified first and second access points and then electing one of the potential coordinates which exists in each of the strength maps as the location coordinates.

In accordance with the implementation of the present disclosure, the controller 1204 may be configured to determine the location coordinates of the asset 1201 by a varied technique which incorporates the usage of the signal strength of the identified first access points 1202 and the identified second access points 1203. The controller 1204 of the present disclosure may be configured to perform one or more arithmetic operations on the signal strengths of the identified first access point(s) 1202 and the signal strengths of the identified second access point(s) 1203 to determine a resultant signal strength. Further, the controller 1204 may be configured to determine the location coordinate of the asset 1201 based on the determined resultant signal strength. Alternatively, the controller 1204 may be enabled to select either the signal strength of the identified first access point(s) 1202 or the identified second access point(s) 1203 based on a pre-defined system operating rules for determining the location coordinates of the asset 1201.

In an alternate embodiment of the present implementation, electronic unit 1301 of the asset 1201 may be only configured to determine the resultant signal strength of the wireless signals received from each of the first access points 1202 and the second access points 1203, and the controller 1204 may be configured to determine the location coordinates of the asset 1201 based on the received signal strength of each of the first and second access points (1202, 1203).

In still another embodiment, the memory 1310 may be enabled to store a floor plan of an indoor space, and the processor 1312 is configured to periodically update the floor plan by marking the location coordinates of each asset on the floor plan. In some embodiments, the processor 1312 is configured to periodically broadcast the updated floor plan via a communication unit of the controller 1204, and the electronic unit 1301 of each of the assets (e.g., asset 1201) are configured to receive the updated floor plan. Based on the received updated floor plan, each asset is enabled to assess nearby assets. The assets may assess nearby assets to prevent collision while maneuvering. Alternatively, in one implementation, the assets may be enabled to generate notification signal to notify a user in an event when nearby assets are within a pre-determined range. The notification signal may correspond to audio, visual, textual, or any combination thereof.

In an embodiment, the plurality of asset (e.g., asset 1201) may be selected from the group consisting of a robotic appliance, a self-propelling device, an assisted propelling device, a non-portable electronic device, and a portable electronic device.

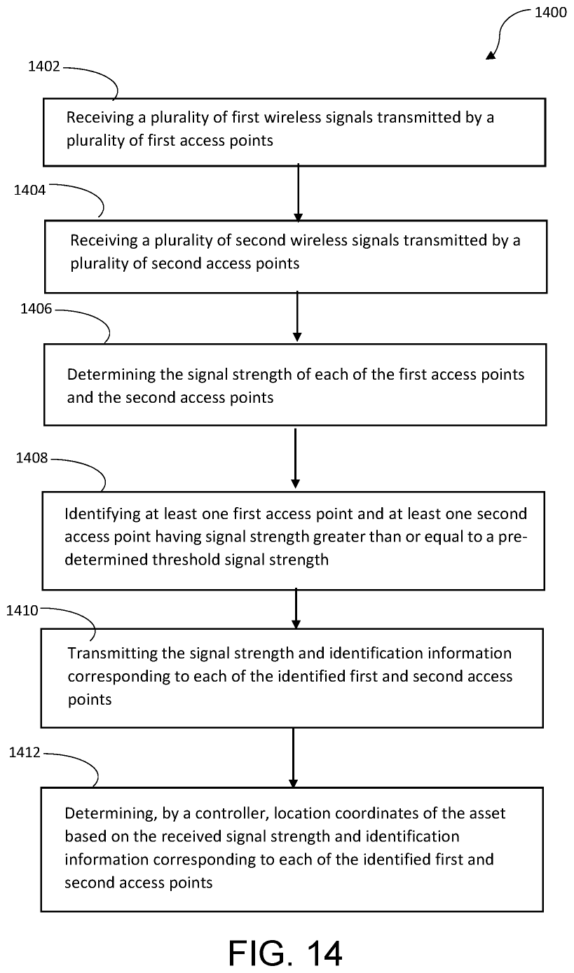

Referring now to FIG. 14, a flow chart of a method 1400 for indoor localization of an asset (e.g., asset 1201) is shown, according to an example embodiment. In some embodiments, the method 1400 is performed by the indoor asset localization system 1200. For example, method 1400 may be performed by the first processor 1304 of the electronic unit 1301. Alternatively, the method 1400 may be partially or completely performed by another system or controller.

Method 1400 is shown to include receiving a plurality of first wireless signals (at step 1402). In some embodiments, the first wireless signals may be transmitted by the plurality of first access points. The first access points may correspond to the access points that are mounted or secured to the ceiling or walls of the indoor space. The method 1400 further includes receiving a plurality of second wireless signals (at step 1404). In some embodiments, the second wireless signals may be transmitted by the plurality of second access points. The second access points may correspond to the access points that are under raised floor mounted access points. The antenna associated with each of the second access points is integrated with a tile of the elevated floor. The method 1400 also includes the step of determining the signal strength (at step 1406) of each of the first and second access points, by the first processor 1304, and subsequently (at step 1408) identifying, one or more first and second access points having signal strength greater than or equal to a pre-determined threshold signal strength. The method further shows, at step 1410, transmitting the signal strength and the identification information of the identified first and second access points by the first processor 1304 via the communication interface 1302 of the indoor asset localization system 1200. In an embodiment, the wireless signals transmitted by the first and second access points includes identification information, where the identification information contains the identity of the respective access point generating and transmitting the wireless signals.

The method 1400 further shows determining (at step 1412) the location coordinates of the asset based on the received signal strength and identification information corresponding to each of the identified first and second access points. The step 1412 may be performed by the controller 1204 of the indoor asset localization system 1200.

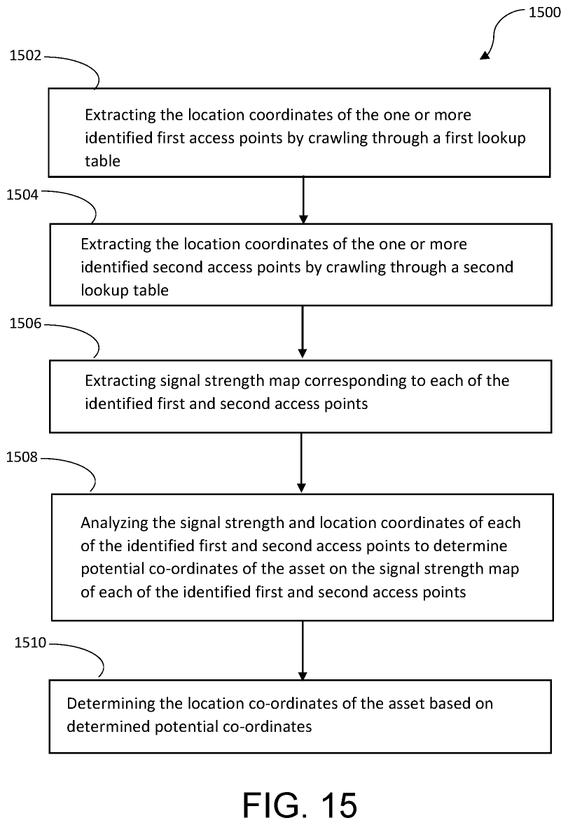

In accordance with an embodiment, FIG. 15 is a flowchart of method 1500 depicting steps performed by the controller 1204 to determine the location coordinates of the asset based on the received signal strength and identification information of each of the identified first and second access points. The method 1500 shows extracting (at step 1502) the location coordinates of one or more identified first access points by crawling through (i.e., analyzing) a first lookup table. The method 1500, further shows extracting (at step 1502) the location coordinates of one or more identified second access points by crawling through a second lookup table. In an embodiment, the controller is configured to extract the location coordinates of the first and second access points from the first and second lookup table based on the identification information received from the first processor of the electronic unit associated the asset. The method 1500 further shows extracting (at step 1506) the signal strength map corresponding to each of the identified first and second access points. Subsequently, at step 1508, the signal strength and the location coordinates of each of the identified first and second access points is analyzed to determine potential coordinates of the asset on signal strength map of each of the identified first and second access points. At step 1510, the method 1500 shows determining the location coordinates of the asset based on the potential coordinates.

The indoor asset localization system 1200 and the method 1400 may be used for monitoring human activities, where the asset 1201 may be associated with a user and the location of the asset may correspond to the location of the user.

The conventional asset localization systems and methods employ only Wi-Fi access points mounted on ceiling and/or walls of the indoor space. On the contrary, the asset localization system of the present system and method additionally employs under raised floor mounted access points, i.e., second access points which improves accuracy of the overall system as the Received Signal Strength Indicator (RSSI) of both first and second access points is taken in to consideration the resultant location coordinates of the asset is more accurate.

### Indoor Navigation System

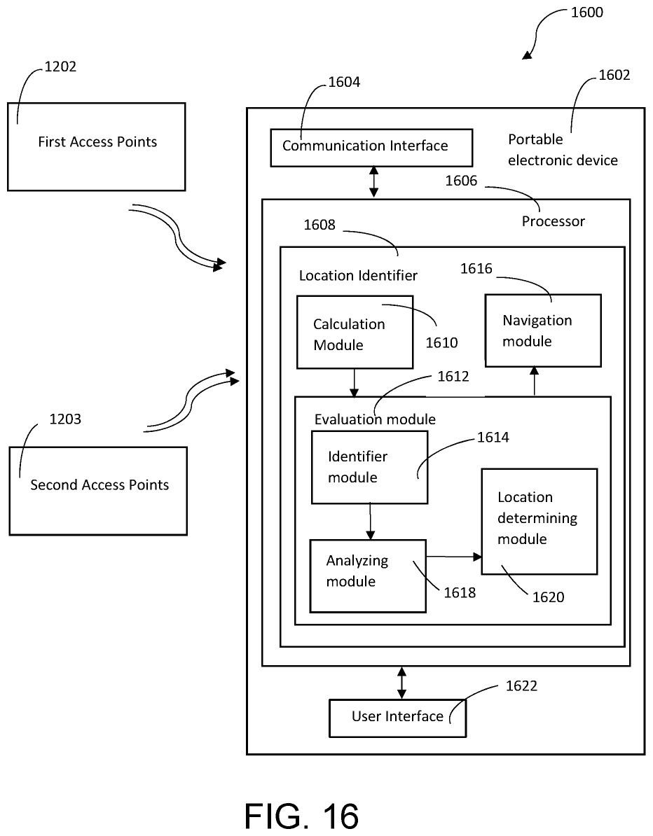

An implementation of the present disclosure includes an indoor navigation system and a method thereof. FIG. 16 refers to a block diagram of an indoor navigation system 1600. In some embodiments, the indoor navigation system 1600 includes a plurality of first access points 1202, a plurality of second access points 1203, and a location identifier 1608. The location identifier 1608 is implemented using one or more processor(s) 1606 of a portable electronic device 1602. The portable electronic device 1602 has communication capabilities that are enabled by a communication interface 1604. In an embodiment, the portable electronic device 1602 can be a stationary terminal or a mobile device. For example, the portable electronic device 1602 can be a laptop computer, a tablet, a smartphone, a PDA, or any other type of mobile or non-mobile device. The portable electronic device 1602 may communicate with the first access points 1202 and the second access points 1203 via a communications link established by the communication interface 1604.

The portable electronic device 1602 can include one or more human-machine interfaces or user interfaces (e.g., graphical user interfaces, reporting interfaces, text-based computer interfaces, client-facing web services, web servers that provide pages to web clients, etc.), such as user interface 1622, for controlling, viewing, or otherwise interacting with indoor navigation system 1600, its subsystems, and/or devices. In some embodiments, the user interface 1622 may be configured to provide an indication of navigation to the processor 1606. The user interface 1622 may provide target location coordinates to the processor 1606. In an embodiment of the present disclosure, the target location coordinates corresponds to the location coordinates of an asset determined using the signal strength of first access points and the signal strength of second access points. In another embodiment, the target location coordinates corresponds to the selection of location coordinates from a floor plan of the indoor space, where the floor plan of the indoor space is pre-stored in a memory of the portable electronic device 1602.

In an embodiment, the first access points 1202 may correspond to the access points mounted on either ceiling 1212 or wall(s) of the indoor space. In an embodiment, each of the first access points 1202 is associated with an antenna (not specifically shown in the figures). The first access points 1202 are configured to transmit first wireless signals within the indoor space via the antenna. The first wireless signal transmitted by each of the first access points 1202 includes an identification information, where the identification information may contains a unique identifier of the associated first access point.

In another embodiment, the second access points 1203 may correspond to under raised floor access points, and are secured on a solid substrate 1210. In this implementation, each of the second access points 1203 is associated with an antenna 1206. The antenna 1206 is integrated with a tile of an elevated floor 1208, where a non-through aperture is configured on the tile to house the antenna 1206. The second access points 1203 are configured to transmit second wireless signals within the indoor space via the antenna 1206. The second wireless signals transmitted by each of the second access points 1203 includes an identification information, where the identification information may include a unique identifier of the associated second access point. Additionally, one or more reflective surfaces are configured on or attached to the inner surface of the non-through aperture to facilitate reflection of portion of second wireless signal emitted by the antenna 1206 and impinging on the reflective surfaces towards the indoor space. Further, in some embodiments, a shielding layer may be configured over the antenna and cover the non-through aperture and also to protect the antenna from the environment. The material selected as shielding layer may have a low wireless signal attenuation.

The location identifier 1608, implemented using the processor 1606, is configured to receive the plurality of first wireless signals and the plurality of second wireless signals. Subsequently, the location identifier 1608 is configured to determine the signal strength of each of the received first and second wireless signals, and may be further configured to evaluate the signal strength and pre-defined the location coordinates of each of the first and second access points to determine the location coordinates of the user, where the location coordinates of the user corresponds to the location coordinates of the portable electronic device 1602 of the user. In an embodiment, the pre-defined location coordinates of the first and second access points is stored in the memory of the portable electronic device. The location identifier 1608 is further configured to generate a navigable route between the determined location coordinates of the user and the target location coordinates. In an embodiment, the navigable route generated by the location identifier 1608 may be displayed on the user interface 1622 of the portable electronic device 1602.

In accordance with an embodiment of the present disclosure, the location identifier 1608 includes a calculation module 1610, an evaluation module 1612, and a navigation module 1616. In some embodiments, the calculation module 1610 may be configured to determine the signal strength of each of the received first and second wireless signals. The evaluation module 1612 may be configured to evaluate the signal strength and pre-defined location coordinates of each of the first and second access points to determine the location coordinates of the user by identifying at least one first access point and at least one second access point having signal strength greater than or equal to a pre-defined threshold signal strength by means of an identifier module 1614. The evaluation module 1612 may be further configured to analyze the signal strength and location coordinates of each of the identified first and second access points to determine potential coordinates of the user on the signal strength map of each of the identified first and second access points (e.g., by means of an analyzing module 1618). The evaluation module 1612 may be further configured to determine the location coordinates of the user by overlapping the signal strength map of each of the identified first and second access points and by electing one of the potential coordinates which exists in each of the strength maps as the location coordinates (e.g., by means of a location determining module 1620). In some embodiments, the signal strength map of each of the first and second access points is stored in the memory of the portable electronic device 1602. In an embodiment, the navigation module 1616 may be configured to generate the navigable route and enable the user interface 1622 of the portable electronic device 1602 to display the navigable route.

In an embodiment, the navigable route generated by the location identifier 1608 is based on shortest path algorithm or any other suitable technique.

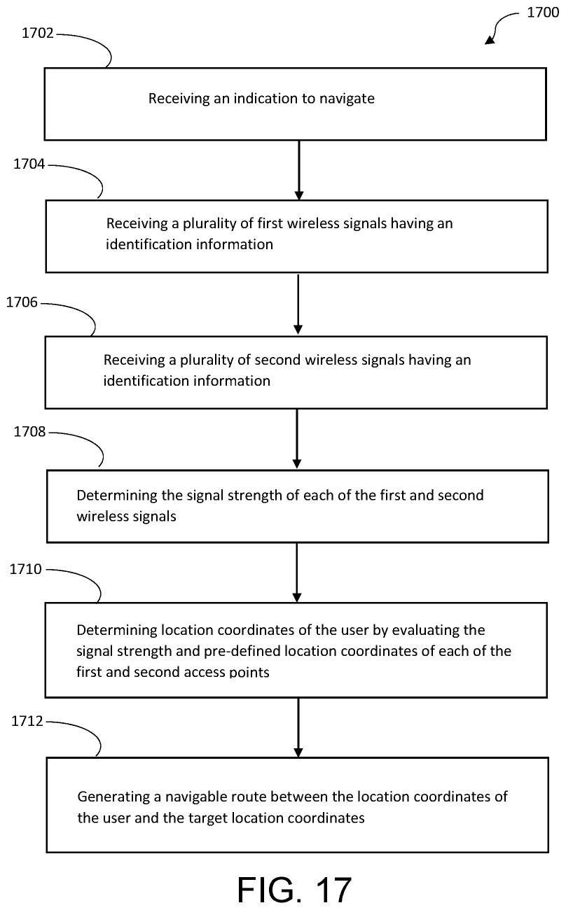

Referring to FIG. 17, method 1700 for indoor navigation is shown. The method 1700 is shown to include the following steps that may be performed by the processor 1606 of the portable electronic device 1602. The method includes receiving (at step 1702) an indication to navigate. In an embodiment, the indication to navigate is received by the processor from the user interface, where the indication to navigate includes a target location coordinates. In some embodiments, the target location coordinates may correspond to location coordinates of an asset determined using the signal strength of first access points and the signal strength of second access points. In another embodiments, the target location coordinates may correspond to selection of a location coordinates from a floor plan of the indoor space, where the floor plan of the indoor space is pre-stored in the memory of the portable electronic device of the user.

The method 1700 is further shown to include receiving (at step 1704), a plurality of first wireless signals having an identification information transmitted by a plurality of first access points, where the first access points are spatially located in an indoor space which includes ceiling and walls. Further, the method 1700 is shown to include receiving (at step 1706) a plurality of second wireless signals having an identification information transmitted by a plurality of second access points, where the second access points are located under an elevated floor, and each of the second access points is associated with an antenna integrated with a tile of the elevated floor. At step 1708, the method 1700 is shown to include determining the signal strength of each of the first and second wireless signals. Subsequently, at step 1710, the method 1700 includes the step of determining the location coordinates of the user by evaluating the signal strength and pre-defined location coordinates of each of the first and second access points. Thereafter, at step 1712, the method 1700 shows generating a navigable route between the location coordinates of the user and the target location coordinates.

In an embodiment, the step 1710 which refers to evaluation of the signal strength and pre-defined location coordinates of the first and second access points to determine the location coordinates of the user further include a plurality of sub-steps. The sub-steps including identifying at least one first access point and at least one second access point having signal strength greater than or equal to a pre-defined threshold signal strength. The sub-steps also include analyzing the signal strength and location coordinates of each of the identified first and second access points to determine potential coordinates of the user on the signal strength map of each of the identified first and second access points. Finally, the sub-steps include determining the location coordinates of the user by overlapping the signal strength map of each of the identified first and second access points and by electing one of the potential coordinates which exists in each of the strength maps as the location coordinates. In some embodiments, the signal strength map of each of the first and second access points is stored in the memory of the portable electronic device.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A floor tile for an elevated floor, the floor tile comprising:
a non-through aperture defining a pocket within the floor tile having a base and one or more walls;
an antenna disposed within the non-through aperture and configured to be communicably coupled to an access point, the antenna configured to transmit wireless signals;
one or more reflective surfaces positioned on an inner surface of the non-through aperture and configured to reflect the wireless signals; and
a shielding layer disposed on top of the antenna and configured to cover the non-through aperture to protect the antenna from an external environment.

2. The floor tile of claim 1, further comprising at least one through-hole extending from the base of the non-through aperture to a bottom of the floor tile, and wherein one or more cables are passed through the at least one through-hole for establishing a connection between the antenna and the access point, the access point being located below the elevated floor.

3. The floor tile of claim 1, further comprising an airtight seal positioned on an outer edge of the floor tile to prevent formation of one or more gaps between the floor tile and one or more adjacent tiles.

4. The floor tile of claim 1, wherein the shielding layer comprises a material having a low wireless signal attenuation.

5. The floor tile of claim 1, wherein the antenna is configured to transmit a portion of the wireless signals upward through an opening of the non-through aperture, and wherein a remaining portion of the wireless signals is reflected by the one or more reflective surface and outward from the floor tile through the opening of the non-through aperture.

6. The floor tile of claim 1, wherein the one or more reflective surfaces are attached to the one or more walls of the non-through aperture.

7. The floor tile of claim 1, wherein the inner surface of the non-through aperture comprises a reflective material.

8. The floor tile of claim 1, wherein the one or more reflective surfaces are positioned such that a shadow region in which the wireless signals are blocked is less than five degrees from the surface of the floor tile.

9. The floor tile of claim 1, wherein the floor tile is a first floor tile, and wherein the elevated floor is defined by a plurality of floor tiles including the first floor tile, the plurality of floor tiles supported on a plurality of columns extending from a solid substrate beneath the elevated floor.

10. A system for locating assets within a building, the system comprising:
one or more access points positioned under an elevated floor of the building and configured to periodically transmit a unique identifier;
one or more antennas coupled to the one or more access points and configured to wirelessly broadcast the unique identifier for a corresponding one of the one or more access points, the one or more antennas disposed within a non-through aperture of one or more tiles of the elevated floor; and
one or more memory devices having instructions stored thereon that, when executed by one or more processors, cause the one or more processors to perform operations comprising:
receiving, from a first asset, first data comprising a unique identifier for a first access point of the one or more access points;
identifying the first access point based on the unique identifier; and
determining location coordinates of the first asset within the building based on a location of the identified first access point.

11. The system of claim 10, wherein:
the unique identifier of the first access point is a first unique identifier;
the first data further comprises a signal strength associated with the wireless broadcast of the first unique identifier; and
determining the location coordinates of the first asset within the building is further based on the signal strength.

12. The system of claim 11, the operations further comprising:
receiving, from the first asset, second data comprising a second unique identifier for a second access point of the one or more access points and a signal strength associated with the wireless broadcast of the second unique identifier; and
identifying the second access point based on the second unique identifier;
wherein determining the location coordinates of the first asset within the building is further based on a location of the identified second access point and the signal strength associated with the second unique identifier.

13. The system of claim 11, wherein determining the location coordinates of the first asset based on a location of the identified first access point and the signal strength comprises:
crawling through a first lookup table to extract the location coordinates corresponding to the unique identifier of the first access point;
analyzing the signal strength and the location coordinates of the first access point to determine a plurality of potential coordinates of the first asset based on a signal strength map; and
determining the location coordinates of the first asset by selecting one of the plurality of potential coordinates as the location coordinates.

14. The system of claim 10, the operations further comprising transmitting, to the first asset, a floor plan indicating a location of the first asset within the building based on the location coordinates and locations of one or more additional assets within the building, wherein the first asset is configured to display the floor plan and the locations via a user interface.

15. The system of claim 10, wherein the first asset is configured to:
receive, prior to transmitting the first data, one or more unique identifiers corresponding to the one or more access points;
determine, for the one or more unique identifiers, a corresponding signal strength; and
identify a subset of the one or more access points having a signal strength greater than a threshold value, the subset of the one or more access points comprising the first access point.

16. The system of claim 10, wherein the one or more access points define a first set of access points, the system further comprising a second set of access points positioned on a wall or ceiling of the building, the second set of access points comprising integrated antennas.

17. The system of claim 16, wherein the unique identifier of the first access point is a first unique identifier, the operations further comprising:
receiving, from the first asset, second data comprising a second unique identifier for a second access point of the second set of access points and a signal strength associated with the wireless broadcast of the second unique identifier;
identifying the second access point based on the second unique identifier; and
determining location coordinates of the first asset within the building based on a location of the identified second access point, the location of the first access point, and the signal strength associated with the first unique identifier and the second unique identifier.

18. The system of claim 10, wherein the non-through aperture of the one or more tiles of the elevated floor comprises one or more reflective surfaces for directing the wireless broadcast of the unique identifier upward from the elevated floor.

19. The system of claim 10, wherein the one or more tiles comprise a shielding layer disposed over a corresponding one of the one or more antennas, the shielding layer having a low wireless signal attenuation and configured to cover the non-through aperture of the one or more tiles to protect the corresponding one of the one or more antennas.

20. A method of locating an asset within a building, the method comprising:
transmitting, by a first access point located under an elevated floor of the building, a wireless signal comprising a unique identifier associated with the first access point, the wireless signal transmitted by a first antenna disposed within a non-through aperture of a tile of the elevated floor and coupled to the first access point;
receiving, by a one or more processors and from a first asset with the building, first data comprising a copy of the unique identifier associated with the first access point and a signal strength associated with a wireless transmission of the unique identifier;
identifying, by the one or more processors, the first access point based on the unique identifier; and
determining location coordinates for the first asset within the building based on a location of the identified first access point and the signal strength.
